(19) United States
(12) Patent Application Publication
(10) Pub. No.: US 2026/0054212 A1
(43) Pub. Date: Feb. 26, 2026

(54) CARBON DIOXIDE REMOVAL FOR ELECTROCHEMICAL POWER STORAGE

(71) Applicant: FORM ENERGY, INC., Somerville, MA (US)

(72) Inventors: Aurora Hope BUNTEN, San Francisco, CA (US); Danielle Cassidy SMITH, Cambridge, CA (US); Grant Harrison FRIESEN, Concord, CA (US); Jhalak Joshipura VASAVADA, San Ramon, CA (US)

(21) Appl. No.: 18/815,751

(22) Filed: Aug. 26, 2024

(51) Int. Cl. B01D 53/14; H01M 12/06

(52) U.S. Cl. CPC B01D 53/1475; B01D 53/1412; H01M 12/06; B01D 2257/504

(57) ABSTRACT

According to one aspect, a system for electrochemical power storage may include a plurality of instances of a metal-air battery, each instance of the metal-air battery including an air electrode, a metal electrode, and a liquid electrolyte separating the air electrode from the metal electrode with the air electrode and the metal electrode ionically coupled to one another via the liquid electrolyte; and a carbon dioxide removal system into which ambient air is directable, carbon dioxide from the ambient air removable in the carbon dioxide removal system to generate purified air, and the carbon dioxide removal system in fluid communication with the plurality of instances of the metal-air batteries such that the purified air is movable from the carbon dioxide removal system to the plurality of instances of the metal-air battery.

### CROSS-REFERENCE TO RELATED APPLICATIONS

This application claims the benefit of priority to U.S. Provisional Patent Application 63/578,545, filed Aug. 24, 2023, the entire contents of which are hereby incorporated herein by reference.

### BACKGROUND

Energy storage technologies are playing an increasingly important role in electric power grids. At a most basic level, these energy storage assets provide smoothing for better matching generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

Electrochemical systems with iron-based negative electrodes are attractive options for electrochemical energy storage. However, there exists a need to improve the design and composition of electrochemical systems having iron-based materials, such as iron-based negative electrodes, to enhance the performance of such systems.

### SUMMARY

Systems, methods, and devices of the various embodiments may include configurations for power systems. Systems and methods of the various embodiments may provide configurations for components of battery systems. Systems and methods of the various embodiments may provide metal-air battery storage systems including a carbon dioxide removal system operable to provide purified air for battery cathodes.

According to one aspect, a system for electrochemical power storage may include a plurality of instances of a metal-air battery, each instance of the metal-air battery including an air electrode, a metal electrode, and a liquid electrolyte separating the air electrode from the metal electrode with the air electrode and the metal electrode ionically coupled to one another via the liquid electrolyte; and a carbon dioxide removal system into which ambient air is directable, carbon dioxide from the ambient air removable in the carbon dioxide removal system to generate purified air, and the carbon dioxide removal system in fluid communication with the plurality of instances of the metal-air batteries such that the purified air is movable from the carbon dioxide removal system to the plurality of instances of the metal-air battery.

In some implementations, the carbon dioxide removal system may include a scrubbing solution in which carbon dioxide from the ambient air is sequesterable to form purified air. For example, the scrubbing solution may include one or more of the following dissolved in a liquid solvent: sodium hydroxide (NaOH), potassium hydroxide (KOH), calcium hydroxide (Ca(OH)2), lithium hydroxide (LiOH), or lithium peroxide (Li2O2). In some instances, the carbon dioxide removal system may include a column vessel having a top portion and a bottom portion opposite one another, the scrubbing solution disposed in the bottom portion of the column vessel, a packing material disposed in the column vessel between the top portion and the bottom portion, the packing material having a porous structure, a solution manifold disposed in the top portion of the column vessel, the solution manifold arranged to direct the scrubbing solution onto the packing material in a direction from the top portion of the column vessel toward the bottom portion of the vessel, and a pump actuatable to move the scrubbing solution from the bottom portion of the column vessel to the solution manifold. In certain instances, the system may further include a liquid flow rate sensor configured to detect a flow rate of the scrubbing solution moving from the pump to the solution manifold, and a controller communicatively coupled to the liquid flow rate sensor and to the pump, the controller configured to receive, from the liquid flow rate sensor, a signal indicative of the flow rate of the scrubbing solution moving from the pump to the solution manifold and, based on the signal from the liquid flow rate sensor, to control the pump such that the flow rate of the scrubbing solution is maintained within a predetermined range of liquid flow rates. In some instances, the carbon dioxide removal system may further include an air blower in fluid communication with the column vessel, wherein the air blower is actuatable to generate an air pressure differential within the column vessel, and the air pressure differential moves the ambient air through the packing material in a direction from the bottom portion of the column vessel toward the top portion of the column vessel. Further, or instead, the carbon dioxide removal system may include an air manifold disposed in the bottom portion of the column vessel, the air blower in fluid communication with the air manifold, and the air blower is actuatable to direct the ambient air into the column vessel, via the air manifold, and through the packing material in a direction from the bottom portion of the column vessel toward the top portion of the column vessel. The carbon dioxide removal system may further include a porous support disposed in the column vessel, and the porous support supports the packing material away the air manifold. In certain instances, the air manifold may define a plurality of first apertures spaced relative to one another such that ambient air moving through the plurality of first apertures is distributed across a first face of the packing material disposed toward the bottom portion of the column vessel, and the solution manifold defines a plurality of second apertures spaced relative to one another such that the scrubbing solution moving through the plurality of second apertures is distributed across a second face of the packing material disposed toward the top portion of the column vessel. In some instances, the carbon dioxide removal system may further include an air outlet in fluid communication with the top portion of the column vessel, and the purified air from the packing material is movable out of the column vessel via the air outlet. As an example, the air blower may be actuatable to draw the ambient air through the packing material in a direction from the bottom portion of the column vessel toward the top portion of the column vessel and draw the purified air out of the column vessel via the air outlet. In certain instances, the system may further include an air pressure sensor arranged to measure a signal indicative of air pressure within the column vessel, and a controller communicatively coupled to the air blower and to the air pressure sensor, the controller configured to receive, from the air pressure sensor, the signal indicative of the air pressure within the column vessel and, based on the signal from the air pressure sensor, to control the air blower such that the air pressure differential within the column vessel is maintained within a predetermined range of pressures. In some instances, the system may further include a gas flow rate sensor arranged to measure a gas flow rate of the ambient air through the air blower, and a controller communicatively coupled to the air blower and to the gas flow rate sensor, the controller configured to receive, from the gas flow rate sensor, a signal indicative of the gas flow rate of the ambient air through the air blower and, based on the signal from the gas flow rate sensor, to control the air blower such that the gas flow rate of the ambient air through the air blower is maintained within a predetermined range of gas flow rates. Further, or instead, the carbon dioxide removal system may include a water inlet valve selectively actuatable to allow water into the scrubbing solution disposed in the bottom portion of the column vessel. In some instances, the carbon dioxide removal system may further include a level sensor arranged to detect a filling level of the scrubbing solution in the bottom portion of the column vessel, and a controller communicatively coupled to the water inlet valve and to the level sensor, the controller configured to receive, from the level sensor, a signal indicative of the filling level of the scrubbing solution in the bottom portion of the column vessel and, based on the signal from the level sensor, to control the water inlet valve such that the filling level of the scrubbing solution in the bottom portion of the column vessel is maintained between a predetermined maximum level and a predetermined minimum level. In certain instances, the carbon dioxide removal system may include a column vessel having a top portion and a bottom portion, the scrubbing solution disposed in the bottom portion of the column vessel, an air sparger immersed in the scrubbing solution in the column vessel, an air blower actuatable to generate air bubbles in the scrubbing solution via the air sparger immersed in the scrubbing solution, a demister disposed in the top portion of the column vessel, vapor from the scrubbing solution in the bottom portion of the column vessel condensable in the demister, and an air outlet in fluid communication with the top portion of the column vessel, the purified air from the scrubbing solution movable out of the column vessel via the air outlet.

In certain implementations, the carbon dioxide removal system may include a column vessel having a top portion and a bottom portion, a scrubbing material having a first side and a second side opposite one another, the scrubbing material having a porous structure from the first side to the second side, carbon dioxide from the ambient air moving through the porous structure sequesterable in the scrubbing material, and the scrubbing material disposed in the column vessel between the top portion and the bottom portion, an air manifold disposed in the bottom portion of the column vessel, the ambient air movable onto the first side of the scrubbing material via the air manifold; a blower actuatable to move the ambient air through the air manifold; and an air outlet in fluid communication with the top portion of the column vessel, the purified air from the second side of the scrubbing material movable out of the column vessel via the air outlet. The scrubbing material may include a metal-organic framework (MOF) in which the carbon dioxide is sequesterable.

### DESCRIPTION OF THE DRAWINGS

FIG. 1 is a system block diagram of a power generation system including a power generation source, a short duration energy storage (SDES) system, and a long duration energy storage (LODES) system, shown located in the same plant.

FIG. 2 is a system block diagram of a power generation system including a power generation source, a short duration energy storage (SDES) system, and a long duration energy storage (LODES) system, shown separated in different plant.

FIG. 3 is a schematic representation of an electrochemical cell.

FIG. 4A is a schematic representation of an enclosure of an electrochemical cell.

FIG. 4B is an exploded view of the enclosure of FIG. 4A.

FIGS. 5A-5D are schematic diagrams of example module configurations including multiple electrochemical cells.

FIGS. 6A-6C are perspective views of portions of an enclosure for a battery module.

FIGS. 7A-7C are schematic representations of example configurations of enclosures for battery modules.

FIGS. 8A-8E are schematic representations of an example layout of battery modules within an enclosure.

FIGS. 9A-9F are schematic representations of an example layout of battery modules within an enclosure.

FIGS. 10A-10E are schematic representations of an example layout of battery modules within an enclosure.

FIG. 11 is a schematic representation of a carbon dioxide removing system including a vessel, a scrubbing solution, an air manifold, a solution manifold, and a packing material, the air manifold and the solution manifold on opposite sides of the packing material in the vessel such that ambient air and scrubbing solution flow countercurrent to one another through the packing material.

FIG. 12 is a schematic representation of a carbon dioxide removal system including a vessel, a scrubbing solution, an air sparger, and a demister, the air sparger immersed in the scrubbing solution in the vessel, the demister disposed in the vessel, and the vapor of the scrubbing solution condensable in the demister.

FIG. 13 is a schematic of a carbon dioxide removal system including a vessel, an air manifold, and a scrubbing material having a porous structure, the air manifold disposed in the vessel and arranged to direct ambient air through the porous structure of the scrubbing material in the vessel.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but to enable a person skilled in the art to make and use this disclosure. Unless otherwise noted, the accompanying drawings are not drawn to scale.

As used herein, unless otherwise specified, the recitation of values herein is merely intended to serve as a shorthand method of referring individually to each separate value falling within the range. Unless otherwise indicated, herein, each individual value within a range is incorporated into the specification as if it were individually recited herein.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this disclosure. Thus, the scope of protection afforded the present inventions should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide metal-air battery storage systems including a carbon dioxide removal system operable to provide purified air for battery cathodes.

Various embodiments may include devices, systems, and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration,” “energy storage cells” including “electrochemical cells,” and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of rated energy to rated power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments shall be understood to encompass other combinations and permutations of storage technologies that may be substituted for the example solar+Li-ion+Fe-air discussions herein. For example, various metal-air storage technologies may be used as batteries in the various embodiments, such as zinc-air, lithium-air, sodium-air, etc.

As used herein, the term “module” may refer to a string of unit cells (e.g., a string of batteries). Multiple modules (or multiple units or cells) may be connected together to form battery strings.

Unless otherwise expressed or made clear from the context, the recitation of any element in the singular shall be understood to be intended to encompass embodiments including one or more such elements and the separate recitation of “one or more” is generally omitted for the sake of clarity and readability. Thus, for example, recitation of a LODES 104 shall be understood to be inclusive of one or more LODES systems, etc.

In the description that follows, all materials (e.g., solids, liquids, gases, or combinations thereof) may flow through conduits (e.g., pipes and/or manifolds) unless specified otherwise or made clear from the context.

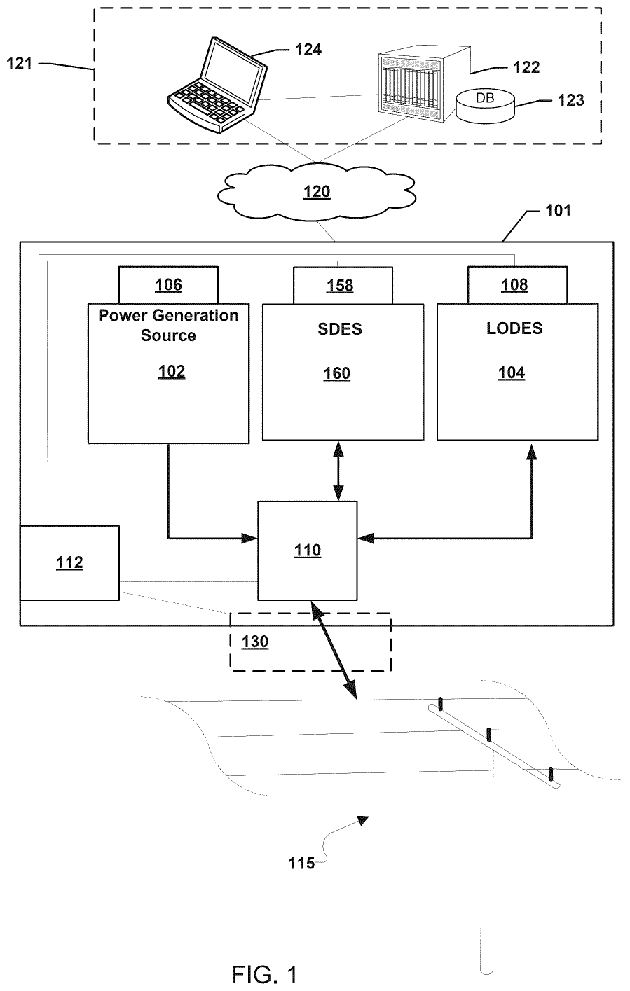

FIG. 1 is a system block diagram of a power generation system 101 (also referred to as a power system) according to various embodiments. The power generation system 101 may be a power plant including one or more power generation sources 102, one or more LODES 104 (e.g., multi-day energy storage (MDS) systems, also referred to herein as a system for electrochemical power storage), and one or more SDES 160. As examples, the power generation sources 102 may be renewable power generation sources, non-renewable power generation sources, combinations of renewable and non-renewable power generation sources, etc. Examples of power generation sources 102 may include wind generators, solar generators, geothermal generators, nuclear generators, etc. The LODES 104 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Al, AlCl3, Fe, FeOx(OH)y, NaxSy, SiOx(OH)y, AlOx(OH)y, metal-air, and/or any suitable type of battery chemistry. The SDES 160 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation sources 102 may be controlled by one or more control systems 106. The control systems 106 may include motors, pumps, fans, switches, relays, or any other type devices that may serve to control the generation of electricity by the power generation sources 102. In various embodiments, the operation of the LODES 104 may be controlled by one or more control systems 108. The control systems 108 may include motors, pumps, fans, switches, relays, or any other type devices that may serve to control the discharge and/or storage of electricity by the LODES system. In various embodiments, the operation of the SDES 160 may be controlled by one or more control systems 158. The control systems 158 may include motors, pumps, fans, switches, relays, or any other type devices that may serve to control the discharge and/or storage of electricity by the SDES system. The control systems 106, 108, 158 may all be connected to a plant controller 112. The plant controller 112 may monitor the overall operation of the power generation system 101 and generate and send control signals to the control systems 106, 108, 158 to control the operations of the power generation sources 102, LODES 104, and/or SDES 160.

In the power generation system 101, the power generation sources 102, the LODES 104, and the SDES 160 may all be connected to one or more power control devices 110. The power control devices 110 may be connected to a power grid 115 or other transmission infrastructure. The power control devices 110 may include switches, inverters (e.g., AC to DC inverters, DC to AC inverters, etc.), relays, power electronics, and any other type devices that may serve to control the flow of electricity from to/from one or more of the power generation sources 102, the LODES 104, the SDES 160, and/or the power grid 115. Additionally, the power generation system 101 may include transmission facilities 130 connecting the power generation, transmission, and power generation system 101 to the power grid 115. As an example, the transmission facilities 130 may connect between the power control devices 110 and the power grid 115 to enable electricity to flow between the power generation system 101 and the power grid 115. Transmission facilities 130 may include transmission lines, distribution lines, power cables, switches, relays, transformers, and any other type devices that may serve to support the flow of electricity between the power generation system 101 and the power grid 115. The power control devices 110 and/or transmission facilities 130 may be connected to the plant controller 112. The plant controller 112 may monitor and control the operations of the power control devices 110 and/or transmission facilities 130, such as via various control signals. As examples, the plant controller 112 may control the power control devices 110 and/or transmission facilities 130 to provide electricity from the power generation sources 102 to the power grid 115, to provide electricity from the LODES 104 to the power grid 115, to provide electricity from both the power generation sources 102 and the LODES 104 to the power grid 115, to provide electricity from the power generation sources 102 to the LODES 104, to provide electricity from the power grid 115 to the LODES 104, to provide electricity from the SDES 160 to the power grid 115, to provide electricity from both the power generation sources 102 and the SDES 160 to the power grid 115, to provide electricity from the power generation sources 102 to the SDES 160, to provide electricity from the power grid 115 to the SDES 160, to provide electricity from the SDES 160 and the LODES 104 to the power grid 115, and/or to provide electricity from the power generation sources 102, the SDES 160, and the LODES 104 to the power grid 115. In various embodiments, the power generation source 102 may selectively charge the LODES 104 and/or SDES 160 and the LODES 104 and/or SDES 160 may selectively discharge to the power grid 115. In this manner, energy (e.g., renewable energy, non-renewable energy, etc.) generated by the power generation source 102 may be output to the power grid 115 sometime after generation from the LODES 104 and/or SDES 160.

In various embodiments, plant controller 112 may be in communication with a network 120 (e.g., 3G network, 4G network, 5G network, core network, Internet, combinations of the same, etc.). Using the connections to the network 120, the plant controller 112 may exchange data with the network 120 as well as devices connected to the network 120, such as a plant management system 121 or any other device connected to the network 120. The plant management system 121 may include one or more computing devices, such as computing device 124 and server 122. The computing device 124 and server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface enabling a user of the plant management system 121 to define inputs to the plant management system 121 and/or power generation system 101, receive indications associated with the plant management system 121 and/or power generation system 101, and otherwise control the operation of the plant management system 121 and/or the power generation system 101.

While illustrated as two separate devices, 124 and 122, the functionality of the computing device 124 and server 122 described herein may be combined into a single computing device or may split among more than two devices. Additionally, while illustrated as a dedicated part of the plant management system 121, the functionality of the computing device 124 and server 122 may be in whole, or in part, offloaded to a remote computing device, such as a cloud-based computing system. While illustrated as in communication with a single instance of the power generation system 101, the plant management system 121 may be in communication with multiple power generation systems.

While illustrated as being geographically located together in FIG. 1, the power generation sources 102, the LODES 104, and the SDES 160 may be separated from one another in various embodiments. For example, the LODES 104 may be downstream of a transmission constraint, such as downstream of a portion of the power grid 115, etc., from the power generation source 102 and SDES 160. In this manner, the over build of underutilized transmission infrastructure may be avoided by situating the LODES 104 downstream of a transmission constraint, charging the LODES 104 at times of available capacity and discharging the LODES 104 at times of transmission shortage. The LODES 104 may also arbitrate electricity according to prevailing market prices to reduce the final cost of electricity to consumers.

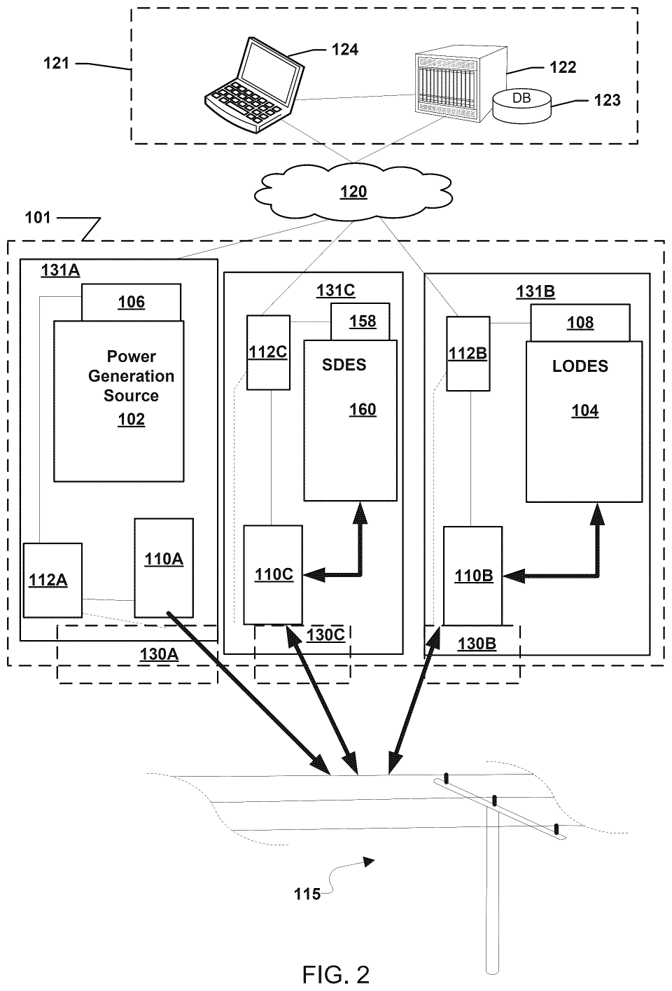

FIG. 2 illustrates an example of a power generation system 101 in which the power generation sources 102 and the bulk energy storage systems, such as the LODES 104 and/or the SDES 160, may be separated from one another according to various embodiments. With reference to FIGS. 1-2, FIG. 2 is similar to FIG. 1, except the power generation source 102, LODES 104, and SDES 160 may be separated in different plants 131A, 131B 131C, respectively. While the plants 131A, 131B, 131C may be separated, the power generation system 101 and the plant management system 121 may operate as described above with reference to FIG. 1. The plants 131A, 131B, and 131C may be co-located or may be geographically separated from one another. The plants 131A, 131B, and 131C may connect to the power grid 115 at different places. For example, the plant 131A may be connected to the grid upstream of where the plant 131B is connected. The plant 131A associated with the power generation sources 102 may include its own respective plant controller 112A and its own respective power control devices 110A and/or transmission facilities 130A. The power control devices 110A and/or transmission facilities 130A may be connected to the plant controller 112A. The plant controller 112A may monitor and control the operations of the power control devices 110A and/or transmission facilities 130A, such as via various control signals. As examples, the plant controller 112A may control the power control devices 110A and/or transmission facilities 130A to provide electricity from the power generation sources 102 to the power grid 115, etc.

The plant 131B associated with the LODES 104 may include its own respective plant controller 112B and its own respective power control devices 110B and/or transmission facilities 130B. The power control devices 110B and/or transmission facilities 130B may be connected to the plant controller 112B. The plant controller 112B may monitor and control the operations of the power control devices 110B and/or transmission facilities 130B, such as via various control signals. As examples, the plant controller 112B may control the power control devices 110B and/or transmission facilities 130B to provide electricity from the LODES 104 to the power grid 115 and/or to provide electricity from the power grid 115 to the LODES 104, etc. The plant 131C associated with the SDES 160 may include its own respective plant controller 112C and its own respective power control devices 110C and/or transmission facilities 130C. The power control devices 110C and/or transmission facilities 130C may be connected to the plant controller 112C. The plant controller 112C may monitor and control the operations of the power control devices 110C and/or transmission facilities 130C, such as via various control signals. As examples, the plant controller 112C may control the power control devices 110C and/or transmission facilities 130C to provide electricity from the SDES 160 to the power grid 115 and/or to provide electricity from the power grid 115 to the SDES 160, etc.

The respective plant controllers 112A, 112B, 112C and respective transmission facilities 130A, 130B, 130C may be similar to the plant controller 112 and transmission facilities 130 described with reference to FIG. 1.

In various embodiments, the respective plant controllers 112A, 112B, 112C may be in communication with the network 120. Using the connections to the network 120, the respective plant controllers 112A, 112B, 112C may exchange data with the network 120 as well as devices connected to the network 120, such as a plant management system 121, each other, or any other device connected to the network 120. In various embodiments, the operation of the plant controllers 112A, 112B, 112C may be monitored by the plant management system 121 and the operation of the plant controllers 112A, 112B, 112C, and thereby the power generation system 101, may be controlled by the plant management system 121.

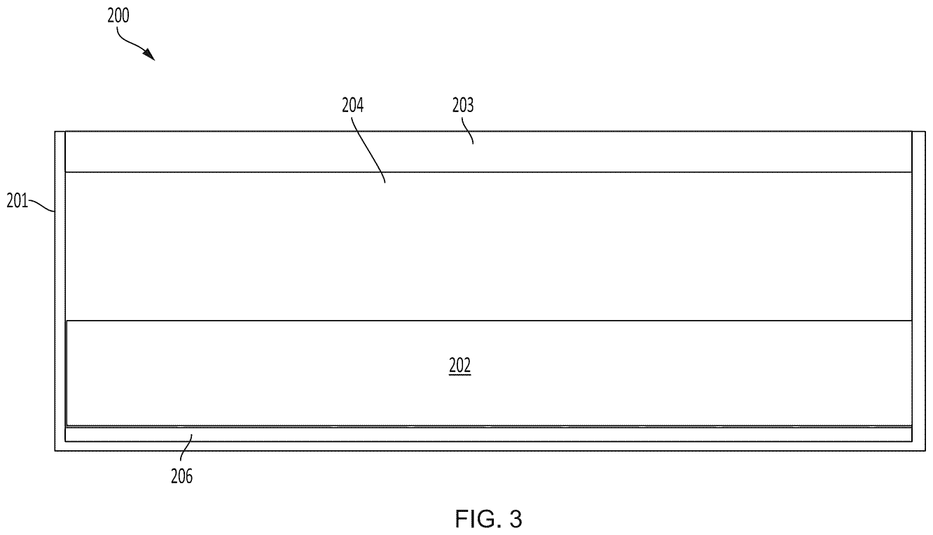

FIG. 3 is a schematic view of a metal-air battery 200, according to various embodiments of the present disclosure. With reference to FIGS. 1-3, the metal-air battery 200 may be one type of battery that may be used in a LODES 104 in various embodiments. Referring to FIG. 3, the metal-air battery 200 includes a vessel 201 in which an air electrode 203 (e.g., a cathode), a metal electrode 202 (e.g., an anode), a liquid electrolyte 204, and a current collector 206 are disposed. The metal electrode 202 may be a metal electrode, such as an iron electrode, lithium electrode, zinc electrode, or other type suitable metal. The liquid electrolyte 204 may separate the air electrode 203 from the metal electrode 202. As examples, the metal-air battery 200 may be a metal-air type battery, such as an iron-air battery, lithium-air battery, zinc-air battery, etc. While various examples are discussed with reference to metal-air batteries, other type batteries may be substituted in the various examples and used in the various embodiments. The metal-air battery 200 may represent a single cell or unit, and multiple instances of the metal-air battery 200 (or multiple units or cells) may be connected together to form battery strings (also referred to as modules).

In various embodiments, the metal electrode 202 may be solid and the liquid electrolyte 204 may be excluded from the anode. In various embodiments the metal electrode 202 may be porous and the liquid electrolyte 204 may be interspersed geometrically with the metal electrode 202, creating a greater interfacial surface area for reaction. In various embodiments, the air electrode 203 may be porous and the electrolyte interspersed geometrically with the air electrode 203, creating a greater interfacial surface area for reaction. In various embodiments, the air electrode 203 may be positioned at the interface of the electrolyte and a gaseous headspace (not shown). In various embodiments, the gaseous headspace may be sealed in a housing. In various other embodiments, the housing may be unsealed and the gaseous headspace may be an open system which can freely exchange mass with the environment.

The metal electrode 202 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. The metal electrode 202 may be referred to herein as the negative electrode or the anode.

In certain embodiments, the battery may be rechargeable and the metal electrode may undergo a reduction reaction when the battery is charged. The metal electrode 202 may be a solid, including a dense or porous solid, or a mesh or foam, or a particle or collection of particles, or may be a slurry, ink, suspension, or paste deposited within the housing. In various embodiments, the metal electrode 202 composition may be selected such that the metal electrode 202 and the volume of liquid electrolyte 204 may not mix together. For example, the metal electrode 202 may be a metal electrode that may be a bulk solid. As another example, the metal electrode 202 may be a collection of particles, such as small or bulky particles, within a suspension that are not buoyant enough to escape the suspension into the electrolyte. As another example, the metal electrode 202 may be formed from particles that are not buoyant in the electrolyte.

The air electrode 203 which may also be referred to as an air electrode, may support the reaction with oxygen on the positive electrode. The air electrode 203 may be a so-called gas diffusion electrode (GDE) in which the cathode is a solid, and it sits at the interface of a gas headspace and the liquid electrolyte 204. During the discharge process, the air electrode 203 supports the reduction of oxygen from the gaseous headspace, the so-called Oxygen Reduction Reaction (ORR). In certain embodiments, the metal-air battery 200 is rechargeable and the reverse reaction occurs, in which the air electrode 203 supports the evolution of oxygen from the battery, the so-called Oxygen Evolution Reaction (OER). The OER and ORR reactions are commonly known to those skilled in the art.

In various embodiments, the liquid electrolyte 204 is a liquid. In certain embodiments, the liquid electrolyte 204 may be an aqueous solution, a non-aqueous solution, or a combination thereof. In various embodiments the liquid electrolyte 204 is an aqueous solution which may be acidic (low-pH), neutral (intermediate pH), or basic (high pH; also called alkaline or caustic). In certain embodiments the liquid electrolyte 204 may comprise an electropositive element, such as Li, K, Na, or combinations thereof. In some embodiments, the liquid electrolyte may be basic, namely with a pH greater than 7. In some embodiments the pH of the electrolyte is greater than 10, and in other embodiments, greater than 12. For example, the liquid electrolyte 204 may comprise a 6M (mol/liter) concentration of potassium hydroxide (KOH). In certain embodiments, the liquid electrolyte 204 may comprise a combination of ingredients such as 5.5M potassium hydroxide (KOH) and 0.5M lithium hydroxide (LiOH). In certain embodiments the electrolyte 140 may comprise a 6M (mol/liter) concentration of sodium hydroxide (NaOH). In certain embodiments the electrolyte 140 may comprise a 5M (mol/liter) concentration of sodium hydroxide (NaOH) and IM potassium hydroxide (KOH).

In certain embodiments, the metal-air battery 200 discharges by reducing oxygen (O2) typically sourced from air. This requires a triple-phase contact between gaseous oxygen, an electronically active conductor which supplies the electrons for the reduction reaction, and an electrolyte 140 which contains the product of the reduction step. For example, in certain embodiments involving an aqueous alkaline electrolyte, oxygen from air is reduced to hydroxide ions through the half-reaction O2+2H2O+4e−→4OH—. Thus, oxygen delivery to metal-air cells requires gas handling and maintenance of triple-phase points. In certain embodiments, called “normal air-breathing” configurations, the air electrode 203 may be mechanically positioned at the gas-liquid interface to promote and maintain triple-phase boundaries. The air electrode 203 may be positioned vertically or horizontally, or at any intermediate angle with respect to gravity, and maintain a “normal air-breathing” configuration. In these “normal air-breathing” configurations, the gas phase is at atmospheric pressure (i.e. it is unpressurized beyond the action of gravity).

The configuration of the metal-air battery 200 in FIG. 3 is merely an example of one electrochemical cell configuration according to various embodiments and is not intended to be limiting. Other configurations, such as electrochemical cells with different type vessels and/or without the vessel 201, electrochemical cells with different type air electrodes and/or without the air electrode 203, electrochemical cells with different type current collectors and/or without the current collector 206, electrochemical cells with different type negative electrodes and/or without the metal electrode 202, and/or electrochemical cells with different type electrolytes and/or electrochemical cells without liquid electrolyte 204 may be substituted for the example configuration of the metal-air battery 200 shown in FIG. 3 and other configurations are in accordance with the various embodiments.

In various embodiments, the vessel 201 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments the vessel 201 and/or housing for the metal-air battery 200 may be made from a metal such as nickel, steel, anodized aluminum, nickel coated steel, nickel coated aluminum or other metal.

In various embodiments, a battery (e.g., the metal-air battery 200) may include three electrodes—an anode (e.g., the metal electrode 202) and a dual cathode (e.g., the air electrode 203 constituted in two parts, such as a first cathode, and a second cathode). The electrodes may have finite useful lifetimes, and may be mechanically replaceable. For example, the anode may be replaced seasonally. The first cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion may be a microporous layer (MPL) of polytetrafluorethylene (PTFE) and high surface area carbon while the first portion may be carbon fiber partially coated with PTFE. As another example, the second portion may be a MPL of PTFE and carbon black and the first portion may be PTFE of approximately 33% by weight. As a further example, the second portion may be an MPL of 23% by weight PTFE and 77% by weight carbon black and the first portion may be a low loading MPL. The anode may be an iron (Fe) electrode or an iron-alloy (Fe-alloy) electrode (e.g., FeAl, FeZn, FeMg, etc.). The second cathode may have a hydrophilic surface. The second cathode may have a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may be comprised of a number of cells connected in series and/or parallel in a shared electrolyte bath and contained in a housing.

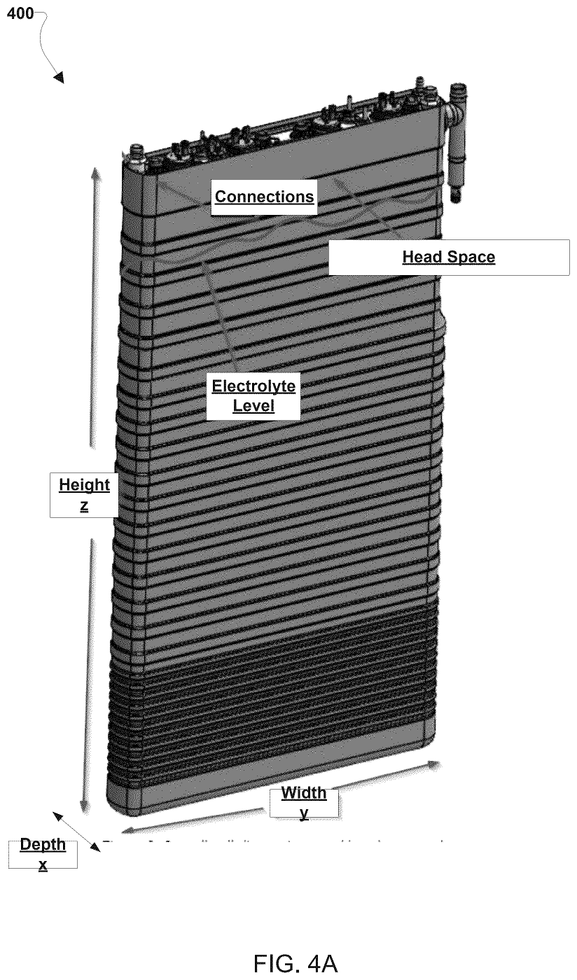

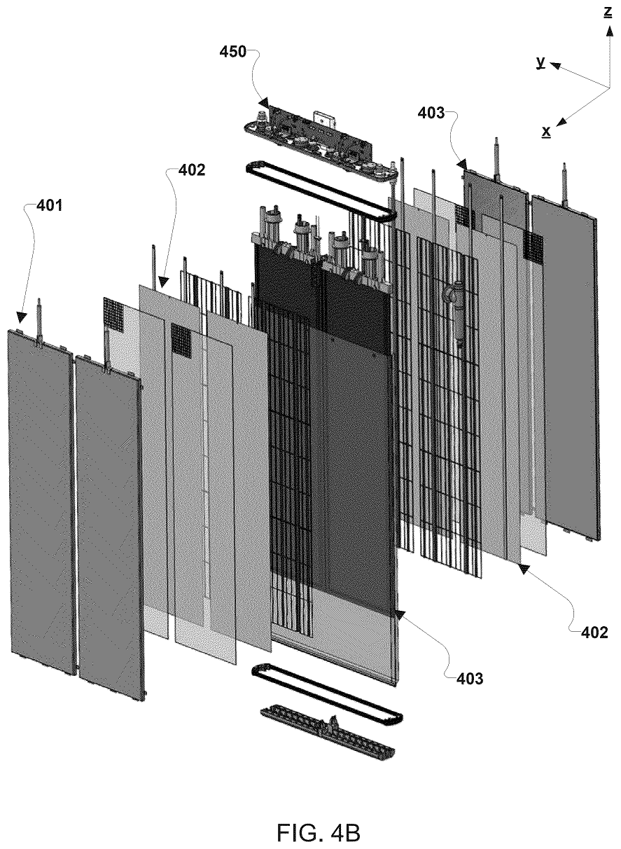

FIG. 4A is a schematic diagram of an example single electrochemical cell (or battery) including an enclosure 400 in accordance with various embodiments. With reference to FIGS. 1-4, the enclosure 400 may contain a battery, such as the metal-air battery 200, in accordance with various embodiments. In some implementations, the enclosure 400 may be the vessel, such as vessel 201, in which an air electrode (e.g., a cathode), such as air electrode 203, a negative electrode (e.g., an anode), such as the metal electrode 202, and an electrolyte, such as the liquid electrolyte 204, are disposed. The electrolyte, such as the liquid electrolyte 204, may rise to a given level within the enclosure 400 and a headspace between the top of the enclosure 400 and electrolyte level may be formed in the enclosure 400. The enclosure 400 may have a height (e.g., a z dimension), a width (e.g., a y dimension), and a depth (e.g., a x dimension). In one example, configuration, the height may be greater than the width and depth and the width may be greater than the depth such that the enclosure 400 is a generally rectangular cuboid. The enclosure 400 may include one or more various connections, such as electrical connections, electrolyte connections, gas connections (e.g., air connections), vents, etc. Via the connections, two or more electrochemical cells (or batteries) may be connected together, such as in series and/or in parallel, to form a module.

Each cell/battery enclosure, such as enclosure 400, in a module may be a self-contained unit supporting its own respective air electrode (e.g., air electrode 203), negative electrode (e.g., the metal electrode 202), and electrolyte (e.g., the liquid electrolyte 204) volume. The module structure may support the cell enclosures, such as enclosures 400, disposed within the module.

FIG. 4B is an exploded view diagram of portions of an inside of the example electrochemical cell (or battery) showing one example configuration of an electrochemical cell (or battery) in accordance with various embodiments. With reference to FIGS. 1-4B, the enclosure 400 may have within it various electrochemical cell (or battery) elements including one or more anode assemblies 401, such as one or more instances of the metal electrode 202, one or more cathode assemblies, such as an air electrode 203, and electrolyte, such as the liquid electrolyte 204. The configuration in FIG. 4B illustrates a two part cathode in which the cathode assembly includes an Oxygen Evolution Electrode (OEE) 402 and a separate gas diffusion electrode (GDE) 403. A battery configuration that includes at least one OEE 402 and at least one GDE 403 may be referred to as a multi-cathode battery cell. The OEE 402 may be disposed within the enclosure between an anode assembly 401 and the GDE 403. The GDE 403 may be disposed in the center of the enclosure 400 and an additional GDE 403 and anode assembly 401 pair may be in a mirror configuration on the opposite side of the GDE 403. Air may enter the enclosure 400 and pass into the center of the GDE 403. Thus, in an example configuration, within the enclosure 400, each electrochemical cell (or battery) may include opposite side anode assemblies 401 each with their own respective OEE 402 in board of the respective anode assemblies 401, with a central GDE 403 with air passage down the center between the two OEEs 402. However, such internal cell (or battery) structure is merely one example configuration of the cell (or battery) that may be within an example enclosure, such as enclosure 400, and is not intended to be limiting. Additionally, the enclosure 400 may include one or more cell electronics structures 450, such as a printed circuit board assembly (PCBA), circuitry housing, etc., supporting various electronic devices, such as controllers, sensors, switches, wiring buses, etc., that may control and/or manage operations of the multi-cathode battery cell.

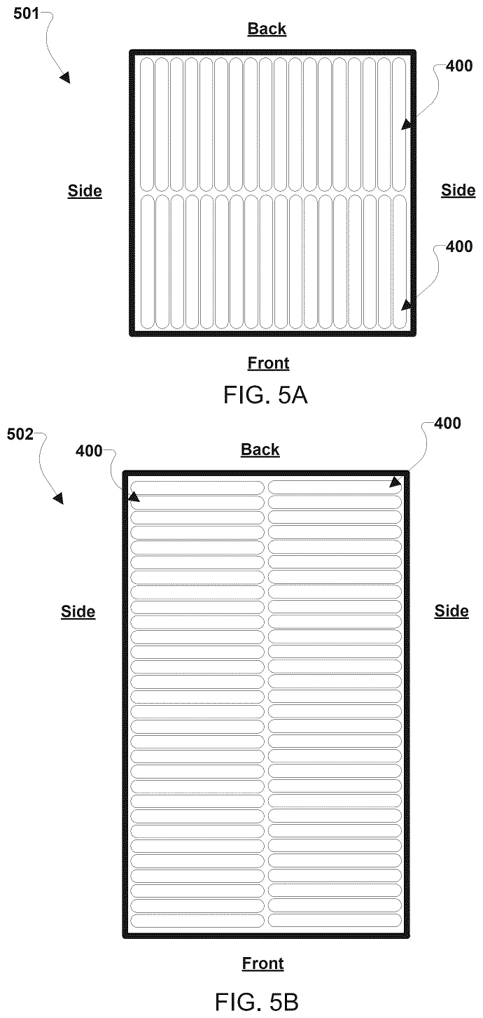

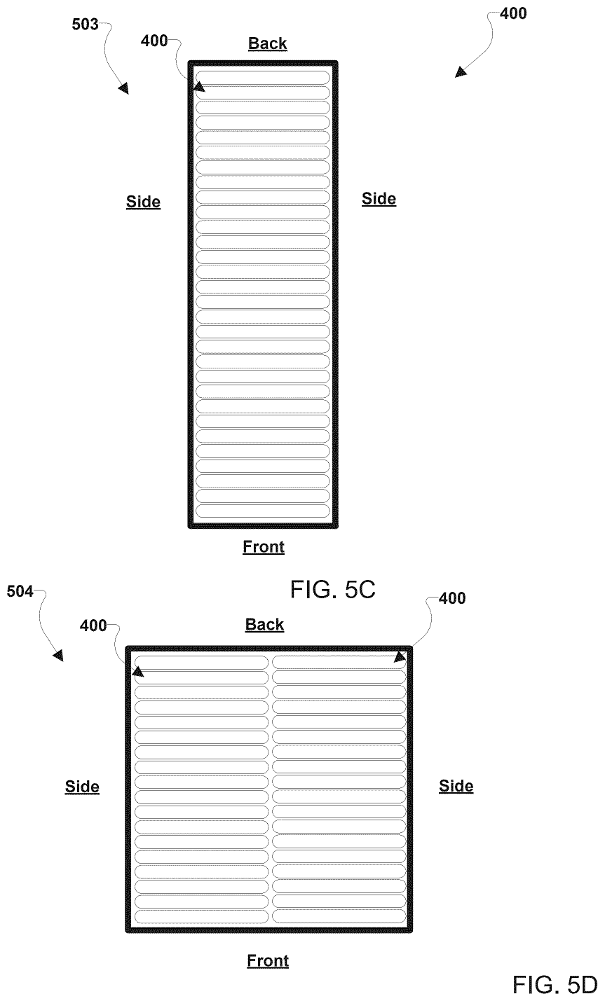

FIG. 5A is a schematic diagram of an example module 501 configuration including multiple instances of the enclosures 400 in accordance with various embodiments. With reference to FIGS. 1-5A, the module 501 is shown from an overhead view looking down the height (e.g., z dimension) of the enclosures 400. The module 501 configuration may be a generally cubic configuration with the front, back, and sides of the module 501 about the same lengths. In the module 501, two rows of the enclosures 400 may be arranged such that the widths of the enclosures 400 run parallel to the sides of the module 501 and the depths of the enclosures 400 run parallel to the front and back of the module 501. In the configuration of the module 501, the widths of the enclosures 400 may generally govern the length of the sides of the module 501 along with any spacing between the rows of enclosures 400 and spacing of the respective rows and the front and back of the module 501. The number instances of the enclosures 400 in each row and the depth of the enclosures 400 may generally govern the length of the front and back of the module 501 along with the spacing between the enclosures 400 in each row and the spacing of the respective rows and the sides of the module 501.

FIG. 5B is a schematic diagram of another example module 502 configuration including multiple instances of the enclosures 400 in accordance with various embodiments. With reference to FIGS. 1-5B, the module 502 is shown from an overhead view looking down the height (e.g., z dimension) of the enclosures 400. The module 502 configuration may be a generally rectangular configuration with the sides of the module 502 longer than the back and front of the module 502. In the module 502, two rows of the enclosures 400 may be arranged such that the widths of the enclosures 400 run parallel to the front and back of the module 502 and the depths of the enclosures 400 run parallel to the sides of the module 502. In the configuration of the module 502, the widths of the enclosures 400 may generally govern the length of the front and back of the module 502 along with any spacing between the rows of enclosures 400 and spacing of the respective rows and the sides of the module 502. The number of instances of the enclosures 400 in each row and the depth of the enclosures 400 may generally govern the length of the sides of the module 502 along with the spacing between the enclosures 400 in each row and the spacing of the respective rows and the front and back of the module 502.

FIG. 5C is a schematic diagram of another example module 503 configuration including multiple instances of the enclosures 400 in accordance with various embodiments. With reference to FIGS. 1-5C, the module 503 is shown from an overhead view looking down the height (e.g., z dimension) of the enclosures 400. The module 503 configuration may be a generally rectangular configuration with the sides of the module 503 longer than the back and front of the module 503. In the module 503, a single row of the enclosures 400 may be arranged such that the widths of the enclosures 400 run parallel to the front and back of the module 503 and the depths of the enclosures 400 run parallel to the sides of the module 502. In the configuration of the module 503, the widths of the single row of the enclosures 400 may generally govern the length of the front and back of the module 503 along with any spacing between the sides of the module 503. The number of instances of the enclosures 400 in the row and the depth of the enclosures 400 may generally govern the length of the sides of the module 503 along with the spacing between the enclosures 400 in the row and the spacing between the front and back of the module 503.

FIG. 5D is a schematic diagram of another example module 504 configuration including multiple instances of the enclosures 400 in accordance with various embodiments. With reference to FIGS. 1-5D, the module 504 is shown from an overhead view looking down the height (e.g., z dimension) of the enclosures 400. The module 504 configuration may be a generally cubic configuration with the front, back, and sides of the module 501 about the same lengths. In the module 504, two rows of the enclosures 400 may be arranged such that the widths of the enclosures 400 run parallel to the front and back of the module 504 and the depths of the enclosures 400 run parallel to the sides of the module 502. In the configuration of the module 504, the widths of the two instances of the enclosures 400 may generally govern the length of the front and back of the module 504 along with any spacing between the rows of enclosures 400 and spacing of the respective rows and the sides of the module 504. The number of instances of the enclosures 400 in each row and the depth of the enclosures 400 may generally govern the length of the sides of the module 504 along with the spacing between the enclosures 400 in each row and the spacing of the respective rows and the front and back of the module 504.

The configuration of the modules 501-504 in FIGS. 5A-5D are merely examples modules including multiple electrochemical cell configurations according to various embodiments and are not intended to be limiting. Other configurations, such modules with more or less rows, modules with no-linear configurations, modules with more or less cells, etc., may be substituted for the example configuration of the modules 501-504 and other configurations are in accordance with the various embodiments.

In various embodiments, battery modules having strings of cells therein, such as modules 501-504, may be enclosed in a module enclosure. A module enclosure may house one or more modules, modules having strings of cells therein, such as modules 501-504.

Modules, such as modules 501-504, deployed in the field may need protection from the elements, such as: wind, dust, snow, rain, seismic activity, etc. The modules, such as modules 501-504, may also need to be secured to the ground to prevent movement in the event of heavy winds and/or seismic activity. Personnel also need to have protections from high voltage, caustic fluids, and any other hazardous conditions associated with the operation of a battery system. There are several auxiliary systems that will also need support for operating the battery energy storage system, including secondary containment, thermal management, hydrogen management, gas diffusion electrode (GDE) support, air supply, electrolyte/water management, etc. Enclosures may be configured in accordance with various embodiments, to provide such support to one or more modules, such as modules 501-504, in a battery system.

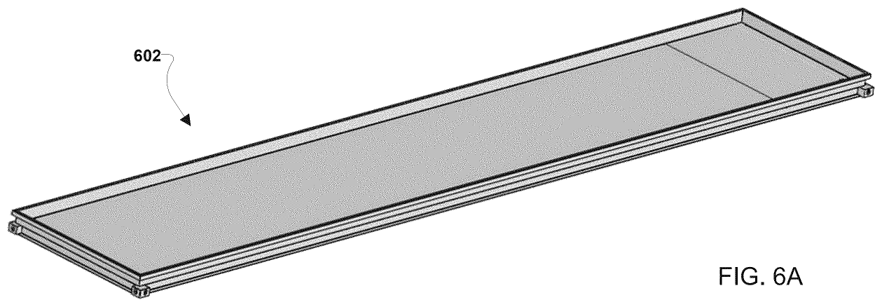

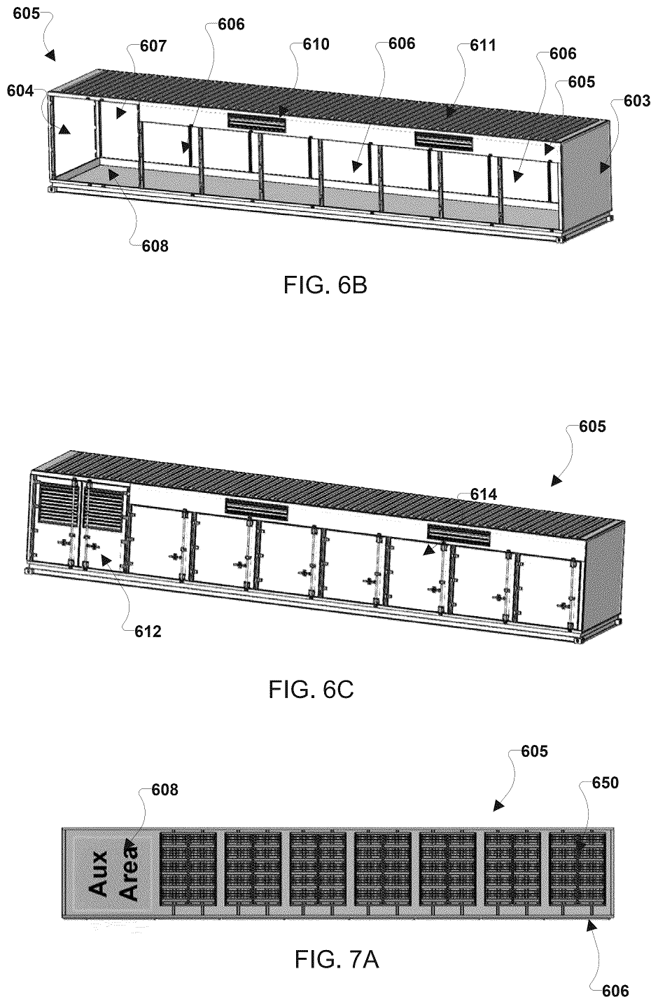

FIGS. 6A-6C illustrate portions of an example enclosure 605 for one or more modules, such as modules 501-504, in a battery system. With reference to FIGS. 1-6C, FIG. 6A illustrates a lower structure 602 of the enclosure 605, FIG. 6B illustrates the enclosure 605 with doors 612 and 614 removed, and FIG. 6C illustrates the enclosure 605 with the doors 612 and 614 installed. Additionally, other doors and/or hatches may be installed along other walls and/or the roof of the enclosure 605. In various embodiments, the lower structure 602 may support the entire weight of the battery modules for transport and installation. A secondary containment may be fabricated into the lower structure 602, for example to handle both the potential for a spill and fire water if it is incorporated in the design. Lifting points will be provided in the lower structure 602 as it can be lifted either by the corners or have additional pick points incorporated along its length. The base of the lower structure 602 may include attachment points to secure the battery modules, such as modules 501-504, to the enclosure 605, for example to support shipping, seismic event dampening, etc. In various embodiments, the enclosure 605 may include any number of modules, such as modules 501-504 therein. The configuration of the enclosure 605 illustrated in FIGS. 6A-6C shows a configuration for at least seven modules, such as modules 501-504, but more or less modules may be present in the enclosure depending on enclosure size and/or configuration. The enclosure 605 may include mounting points provided to attach to a variety of field installation structures, such as grade beams, piles, helical piers, foundations, etc., upon deployment in the field.

In some embodiments, the enclosure may include an auxiliary area 608 at one end of the enclosure in which auxiliary equipment to support the modules, such as modules 501-504, may be mounted. Auxiliary equipment may include, pumps, blowers, controllers, switches, connections, tubing, ducting, heaters, chillers, filters, reservoirs, tanks, electronics, or any other type of equipment that may support the operation of the modules, such as modules 501-504, within the enclosure 605. The support subsystems may be housed in the auxiliary area 608 and connected to the modules, such as modules 501-504. The support subsystems may include GDE air systems, thermal management systems, heating systems, hydrogen management systems, water and/or electrolyte management systems, power electronics systems, controls electronics systems, communication systems, telemetry sensors and equipment, and/or disconnects from plant level services, as well as any other type of subsystems.

The floor of the enclosure 605 may also have perforations to allow for stub ups of electrical, water, or any other desired connection to be made upon installation in the field as long as the perforation is properly designed to maintain the secondary containment requirements of the lower structure.

As illustrated in FIGS. 6B and 6C, walls 603, 604, and 607 may be attached to the lower structure 602, and designed to support any snow loads taken up by the roof 611, as well being designed to handle wind loads. This structural shell may also provide a for mounting any of the auxiliary subsystems that need to be run throughout the enclosure 605. While illustrated as walls 603, 604, and 607 and roof 611, all or portions of the walls and/or roof may be formed from other materials, such as fabric, cloth, etc. In various configurations, the enclosure may be formed into different areas, such as the auxiliary area 608 and module bays 606. In various embodiments, the auxiliary area 608 may be covered by a door 612 on one or both long sides of the enclosure 605 and module bays 606 may be covered by doors 614 on one or both long sides of the enclosure 605. The doors 612 and/or 614 may enable access to the auxiliary equipment and/or modules for servicing and/or replacement. In some embodiments, perforations 610 may be present in the walls 603, 604, 607 and/or roof 611 to allow for air to be exchanged from ambient to the enclosure 605 and vice versa. Filter grates may be one example of the perforations 610. The configuration of the enclosure 605 may maintain low dust intrusion and/or protect against driven rain.

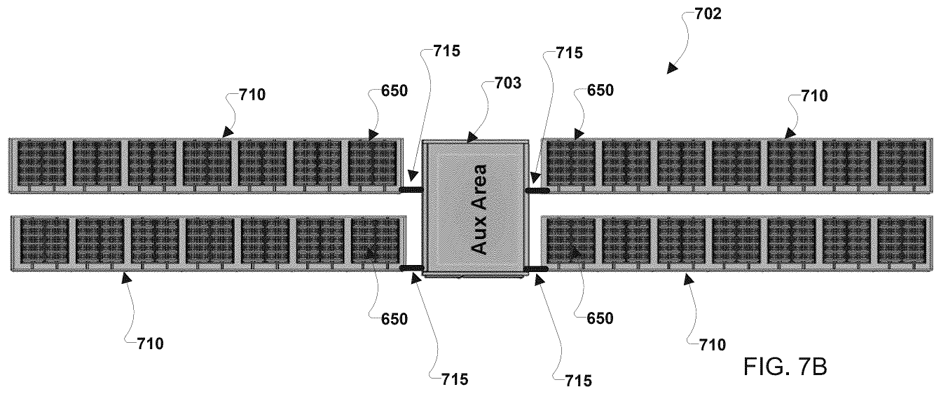

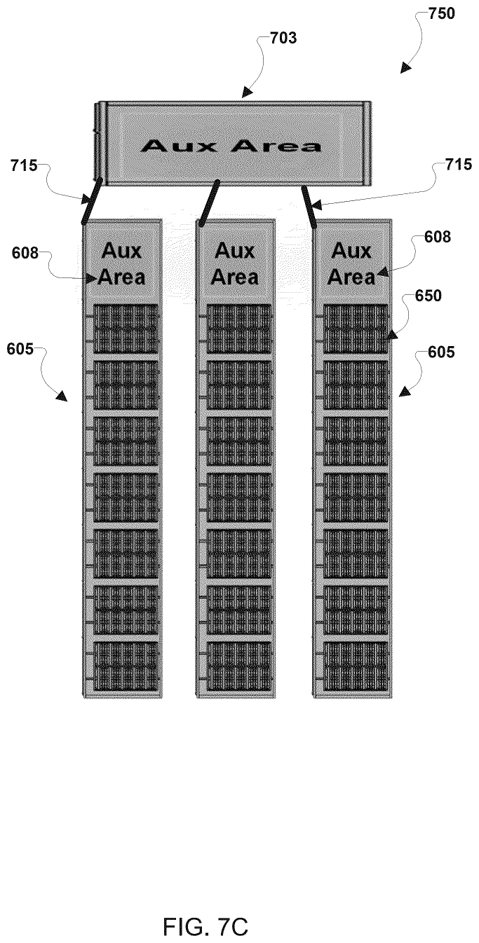

FIGS. 7A-7C illustrate battery module enclosure configurations in accordance with various embodiments. With reference to FIGS. 1-7C, FIG. 7A illustrates a top-down view of example enclosure 605 in which the auxiliary area 608 is within the enclosure 605 and co-located with the modules 650, such as modules 501-504, within the module bays 606. While seven sets of modules are illustrated in FIG. 7A, this is merely one example, and more or less modules may be present in the enclosure 605.

FIG. 7B illustrates an alternative configuration 702 in which the enclosures 710 supporting the modules 650, such as modules 501-504, may not include auxiliary areas therein, and rather a central auxiliary area 703 may support one or more enclosures 710. This separate auxiliary area 703 enclosure may be connected to the modules by one or more connections 715 and the auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the enclosures 710 and the modules 650 therein. While four enclosures 710 are illustrated in FIG. 7B, more or less enclosures 710 may be connected to the auxiliary area 703 and the auxiliary area 703 may be sized according to the number of enclosures to support and number of modules within the enclosures.

FIG. 7C illustrates an alternative configuration 750 in which a separate auxiliary area 703 enclosure is connected to the enclosures 605 which also have auxiliary areas 608 therein. In this manner, some auxiliary system functions may be in whole, or in part, offloaded to the separate auxiliary area 608 and some auxiliary system functions may in whole, or in part, remain at the enclosure 605 level.

While FIGS. 7A-7C illustrate various configurations for enclosures and/or auxiliary areas, the configurations illustrated in FIGS. 7A-7C are merely examples according to various embodiments and are not intended to be limiting. Other configurations of enclosures and/or auxiliary areas may be substituted for the example configuration of FIGS. 7A-7C and other configurations are in accordance with the various embodiments.

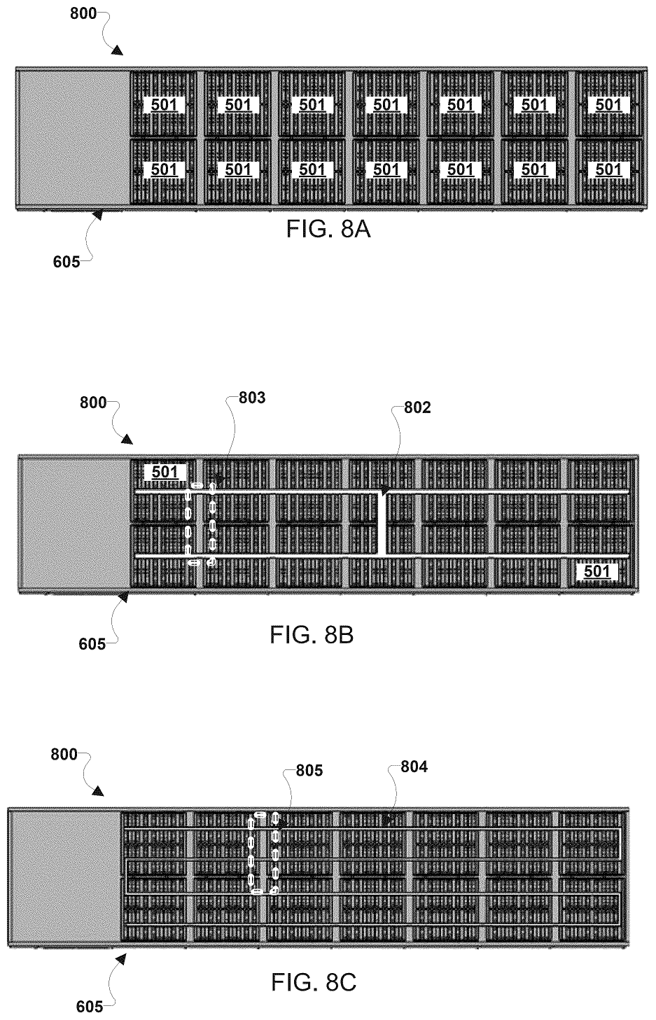

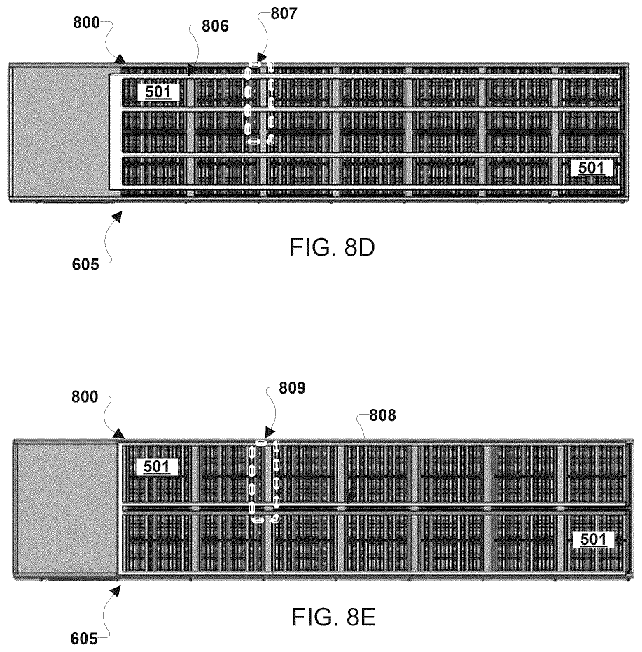

FIGS. 8A-8E illustrate an example module 501 layout 800 within an enclosure 605 in accordance with various embodiments. With reference to FIGS. 1-8E, FIGS. 8A-8E illustrate a layout 800 in which two modules 501 are arranged front to back within a module bay. In the layout 800, electrical routing may be provided, and all hookups may be on the enclosure 605 short end. In the layout 800, space may be required within the enclosure 605 for module removal. In the layout 800, electrode width may be tied to the smallest enclosure 605 dimension. In the layout 800, thermal spacing may be tied to the smallest enclosure dimension. Layout 800 may require connection and/or disconnection of a back module 501 of the two modules 501 in each module bay. Layout 800 may require some activities of personnel to be performed in the enclosure.

FIG. 8B illustrates an example thermal management ducting/plumbing system configuration 803 and connections 804 needed to be made inside the enclosure 605 to install and/or remove a module 501. FIG. 8C illustrates an example electrical system connection configuration 804 and connections 805 needed to be made inside the enclosure 605 to install and/or remove a module 501. FIG. 8D illustrates an example GDE air system connection configuration 806 and connections 807 needed to be made inside the enclosure 605 to install and/or remove a module 501. FIG. 8E illustrates an example water and/or electrolyte system connection configuration 808 and connections 809 needed to be made inside the enclosure 605 to install and/or remove a module 501.

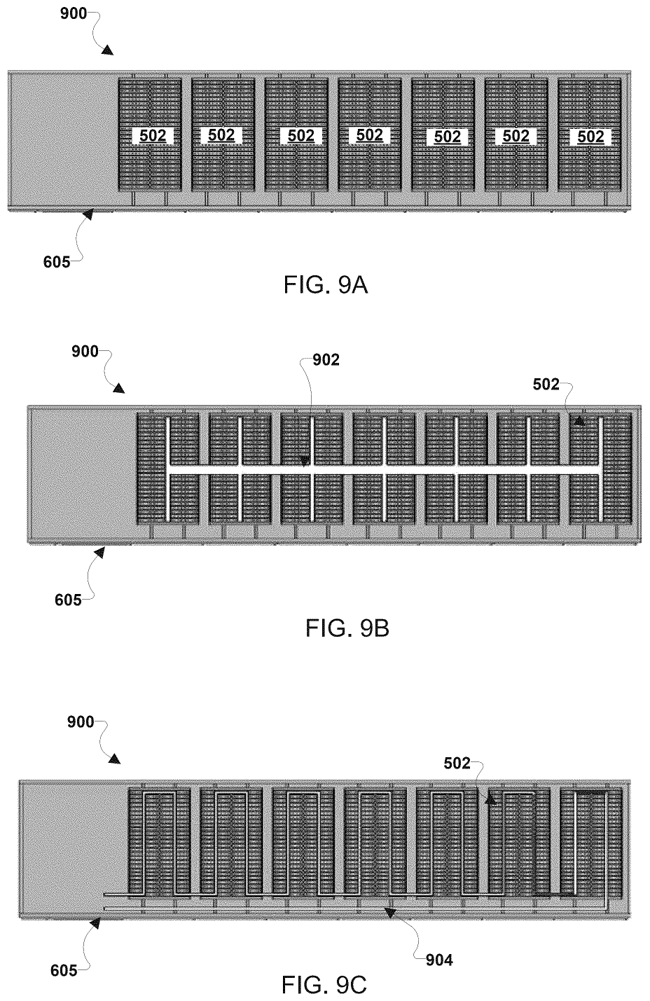

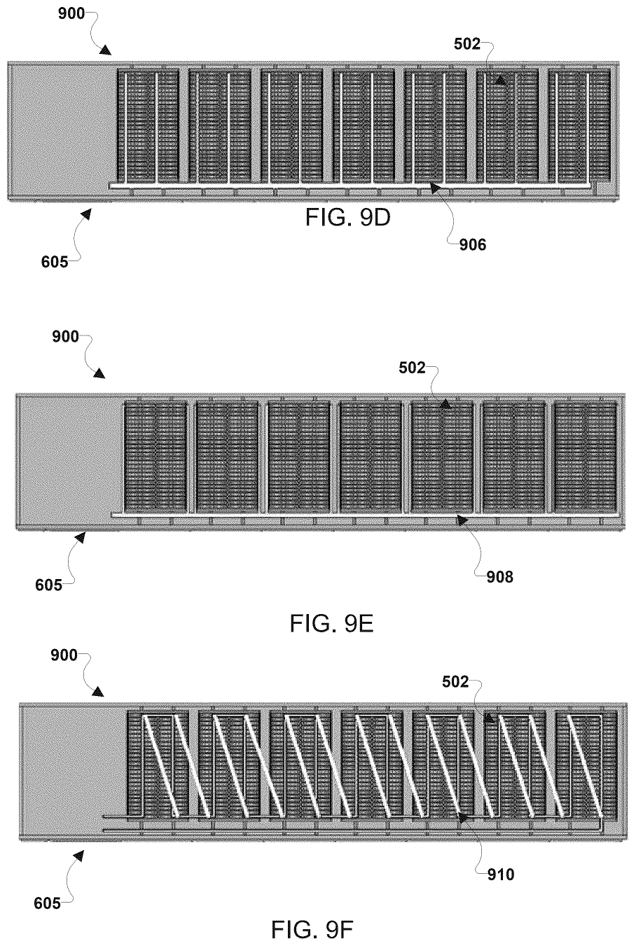

FIGS. 9A-9F illustrate an example module layout 900 within an enclosure 605 in accordance with various embodiments. With reference to FIGS. 1-9F, FIGS. 9A-9F illustrate a layout 900 in which a module 502 may be arranged within each module bay. In the layout 900, the module connections may be at the doors of the module bays.

FIG. 9B illustrates an example thermal management ducting/plumbing system configuration 902 inside the enclosure 605. FIG. 9C illustrates an example electrical system connection configuration 904 inside the enclosure 605. FIG. 9D illustrates an example GDE air system connection configuration 906 inside the enclosure 605. FIG. 9E illustrates an example water and/or electrolyte system connection configuration 908 inside the enclosure 605. FIG. 9F illustrates an optional second electrical system connection configuration 910 (shown in white) including blind mating at the back of the modules 502 and front side connections.

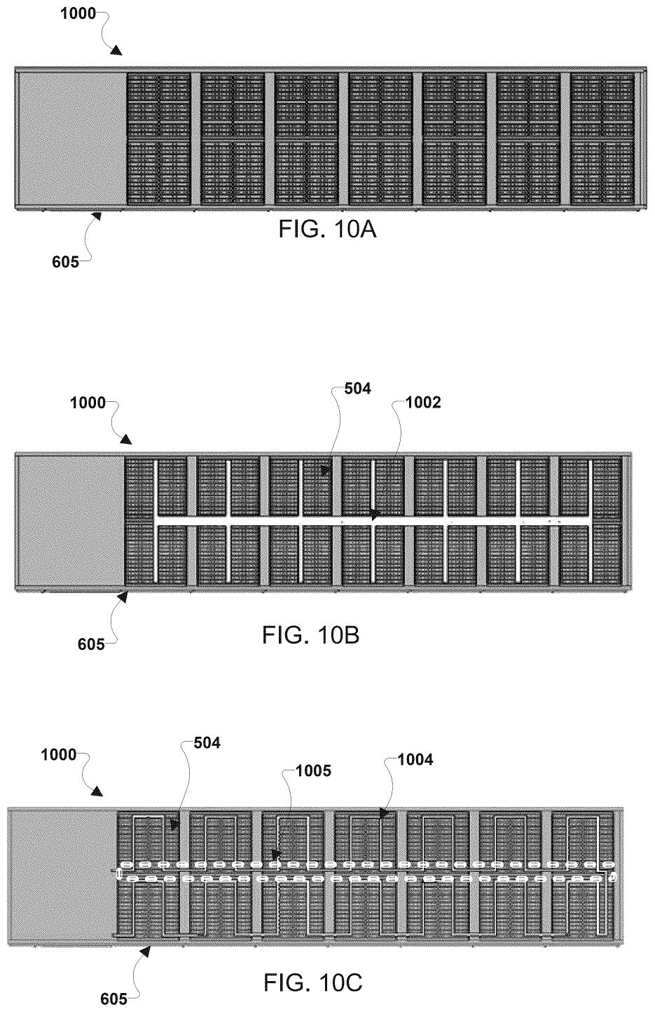

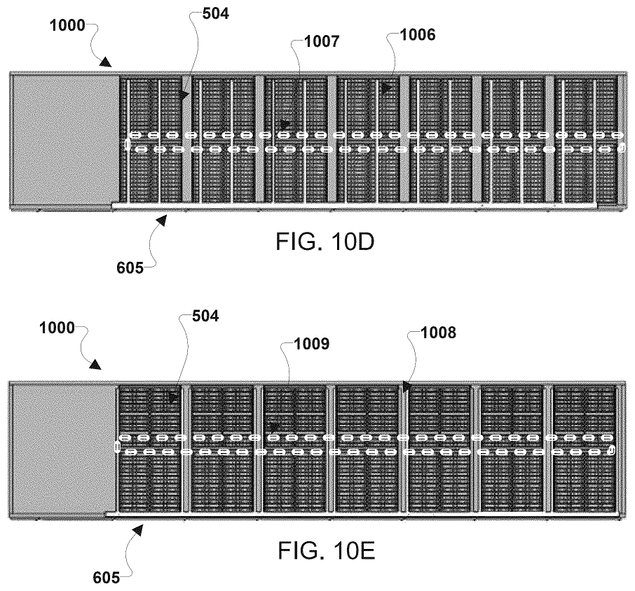

FIGS. 10A-10E illustrate an example module 504 layout 1000 within an enclosure 605 in accordance with various embodiments. With reference to FIGS. 1-10E, FIGS. 10A-10E illustrate a layout 1000 in which two modules 504 are arranged front to back within a module bay. In the layout 1000, space may be required within the enclosure 605 for module removal. In the layout 1000, electrode width may be independent of enclosure 605 width. Layout 1000 may require connection and/or disconnection of a back module 504 of the two modules 504 in each module bay. Layout 1000 may require some activities of personnel to be performed in the enclosure.

FIG. 10B illustrates an example thermal management ducting/plumbing system configuration 1003 inside the enclosure 605. FIG. 10C illustrates an example electrical system connection configuration 1004 and connections 1005 needed to be made inside the enclosure 605 to install and/or remove a module 504. FIG. 10D illustrates an example GDE air system connection configuration 1006 and connections 1007 needed to be made inside the enclosure 605 to install and/or remove a module 504. FIG. 10E illustrates an example water and/or electrolyte system connection configuration 1008 and connections 1009 needed to be made inside the enclosure 605 to install and/or remove a module 504.

While FIGS. 8A-10E illustrate various configurations for enclosures and modules within those enclosures, the configurations illustrated in FIGS. 8A-10E are merely examples according to various embodiments and are not intended to be limiting. Other configurations for enclosures and modules within those enclosures may be substituted for the example configuration of FIGS. 8A-10E and other configurations are in accordance with the various embodiments.

### Carbon Dioxide Removal

The discharging reaction of a metal-air battery system, such as any one or more of the various, different iron-air battery systems described herein, may consume oxygen. Ambient air may be provided to the air electrodes of battery cells of a metal-air battery system as a low-cost source of oxygen. However, ambient air includes carbon dioxide (CO₂), which may be transported through the GDE of a metal-air battery and into the battery electrolyte, where the CO₂ may react within the electrolyte to form carbonate. Over time, accumulation of the carbonate in the electrolyte may reduce the conductivity of the electrolyte, degrading electrolyte performance and, in turn, degrading performance of the metal-air battery system.

Accordingly, a system for electrochemical energy storage, such as any one or more of the various, different systems described herein, may additionally or alternatively include a carbon dioxide removal system in fluid communication with any one or more of the battery cells of any one of the metal-air battery systems described herein and operable to remove at least a portion of CO₂ content from ambient air to provide purified air to battery cells of a metal-air battery system. As may be appreciated from the foregoing, the term “purified air” as used herein includes air having volumetric CO₂ fraction less than that of ambient air, such as ambient air immediately outside of the carbon dioxide removal system and drawn into the carbon dioxide removal system. As an example, a carbon dioxide reduction system may reduce the volumetric CO₂ content of ambient air to provide purified air to the enclosures 400 (FIGS. 4A and 4B) and to the GDE 403 (FIG. 4B) within the enclosures 400. As an example, the purified air (air with the reduced CO₂ content relative to ambient air) may be provided to a GDE air system (e.g., the GDE air system 806 (FIG. 8D), the GDE air system 906 (FIG. 9D), and/or the GDE air system 1006 (FIG. 10D)) supplying air to the enclosures 400 (FIGS. 4A and 4B) within modules (e.g., the module 501 (FIG. 5A), the module 502 (FIG. 5B), the module 503 (FIG. 5C), the module 504 (FIG. 5D), and/or the module 650 (FIGS. 7A-7C)), within enclosures (e.g., the enclosure 605 (FIGS. 6B-6C) and/or the enclosure 710 (FIG. 7B)). Further, or instead, unless otherwise specified or made clear from the context, any one or more of the carbon dioxide removal systems described herein may be system may be an example of an auxiliary system that may be present in an auxiliary area (e.g., the auxiliary area 608 (FIG. 7C) and/or the auxiliary area 703 (FIG. 7B and FIG. 7C)).

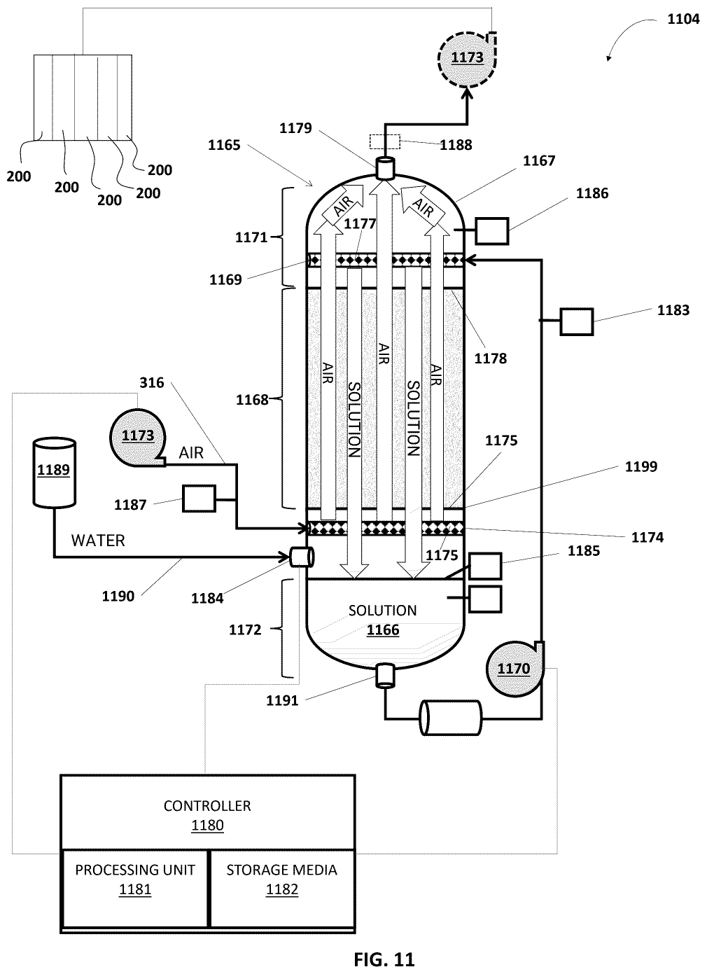

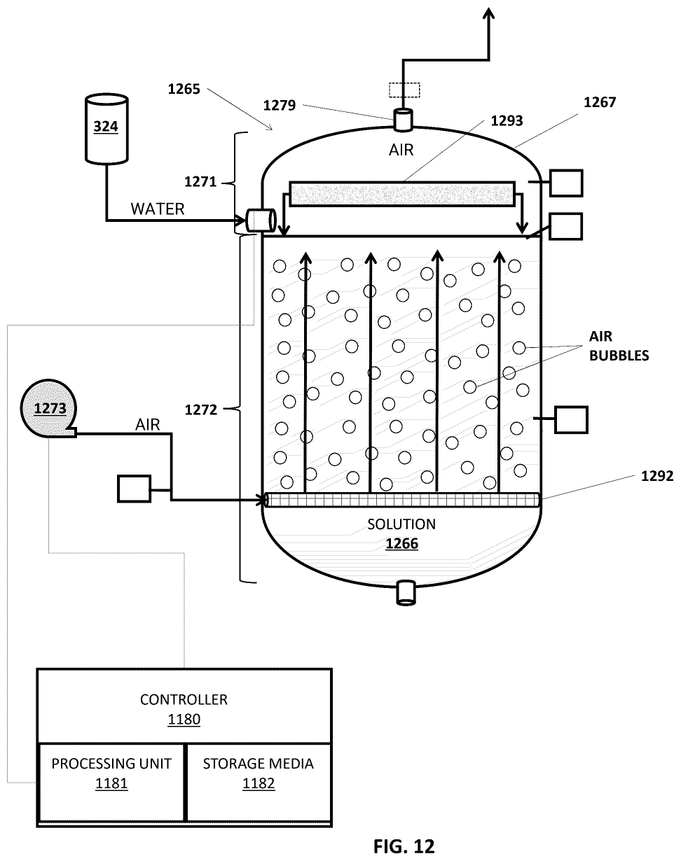

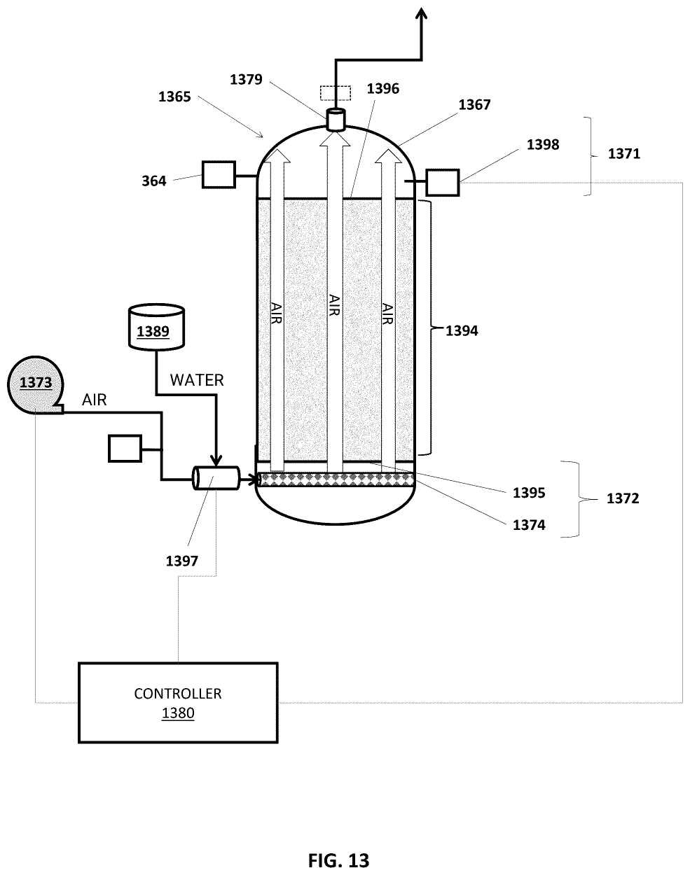

For the sake of clear and efficient description, elements numbers having the same last two digits in the disclosure that follows in relation to FIGS. 11-13 shall be understood to be analogous to or interchangeable with one another, unless otherwise explicitly stated or made clear from the context and, therefore, are not described separately from one another, except to note difference or to emphasize certain features. Thus, for example, a LODES 104 in FIG. 2 and a system for electrochemical power storage 1104 in FIG. 11 shall be understood to be analogous to or interchangeable with one another, unless otherwise specified or made clear from the context.

Referring now to FIGS. 1-11, a system for electrochemical power storage 1104 may include a plurality of instances of the metal-air battery 200 and a carbon dioxide removal system 1165 in fluid communication with one another. The metal-air battery 200 may include the air electrode 203, the metal electrode, and the liquid electrolyte with the liquid electrolyte separating the air electrode from the metal electrode and with the air electrode and the metal electrode ionically coupled to one another via the liquid electrolyte. In general, ambient air may be directable into the carbon dioxide removal system 1165, the carbon dioxide removal system 1165 may remove at least a portion of the carbon dioxide content of the ambient air to generate purified air, and the purified air may be movable from the carbon dioxide removal system 1165 to the plurality of instances of the metal-air battery 200.

In certain implementations, the carbon dioxide removal system 1165 may include a scrubbing solution 1166 in which carbon dioxide from the ambient air may be sequestered to form purified air. That is, as described in greater detail below, the ambient air may be directed through and/or onto the scrubbing solution 1166 such that the scrubbing solution 116 removes at least a portion of the carbon dioxide from the ambient air to form purified air. In certain implementations, the scrubbing solution 1166 may react with carbon dioxide to form carbonate, which may become sequestered in the scrubbing solution 1166. In some instances, the scrubbing solution 1166 may include a strong base carbon dioxide sequestering material dissolved in a liquid solvent such as water. Examples of the scrubbing solution 1166 may include one or more of the following dissolved in a liquid solvent (e.g., water): sodium hydroxide (NaOH), potassium hydroxide (KOH), calcium hydroxide (Ca(OH)2), lithium hydroxide (LiOH), or lithium peroxide (Li2O2).

As an example, the carbon dioxide removal system 1165 may include a column vessel 1167, a packing material 1168, a solution manifold 1169, and a pump 1170. The column vessel 1167 may have a top portion 1171 and a bottom portion 1172 opposite one another, and the scrubbing solution 1166 may be disposed in the bottom portion of the column vessel 1167. The packing material 1168 may be disposed in the column vessel 1167 between the top portion 1171 and the bottom portion 1172, with the packing material 1168 having a porous structure. In general, the packing material 1168 may be any high surface area packing material (e.g., dump packing, random packing, and/or structural packing) that may facilitate increasing contact between the scrubbing solution 1166 and the ambient air moving through the porous structure of the packing material 1168. In certain implementations, the solution manifold 1169 may be disposed in the top portion 1171 of the column vessel 1167 and arranged to direct the scrubbing solution 1166 onto the packing material 1168 in a direction from the top portion 1171 of the column vessel 1167 to the bottom portion 1172 of the column vessel 1167. Further, or instead, the pump 1170 may be actuatable to move the scrubbing solution 1166 from the bottom portion 1172 of the column vessel 1167 to the solution manifold 1169 in the top portion 1171 of the column vessel 176 such that the scrubbing solution 116 that collects in the bottom portion 1172 of the column vessel 1167 may be recirculated (e.g., continuously) through the porous structure of the packing material 1168 as ambient air moves through the porous structure of the packing material 1168.

In some implementations, the carbon dioxide removal system 1165 may further, or instead, include an air blower 1173 in fluid communication with the column vessel 1167. In general, the air blower 1173 may be actuatable to generate an air pressure differential within the column vessel 1167. In turn, the air pressure differential generated by the air blower 1173 may move the ambient air through the packing material 1168 in a direction from the bottom portion 1172 of the column vessel 1167 toward the top portion 1171 of the column vessel 1167. With air moving in the direction from the bottom portion 1172 of the column vessel 1167 toward the top portion 1171 of the column vessel 1167 and the scrubbing solution 1166 moving in a direction from the top portion 1171 of the column vessel 1167 toward the bottom portion 1172 of the column vessel 1167, the air and the scrubbing solution 1166 may move countercurrent to one another through the porous structure of the packing material 1168. Continuing with this example, as the air moves countercurrent to the scrubbing solution 1166 in the porous structure of the packing material 1168, the scrubbing solution 1166 may sequester at least a portion of the carbon dioxide in ambient air to generate purified air moving toward the top portion 1171 of the column vessel 1167.

In some implementations, the carbon dioxide removal system 1165 may additionally, or alternatively, include an air outlet 1179 in fluid communication with the top portion 1171 of the column vessel 1167, and purified air from the packing material 1168 may be movable out of the column vessel 1167 via the air outlet 1179. From the air outlet 1179, the purified air may be directed to the plurality of instances of the metal-air battery 200, where the purified air may serve as a low-cost oxygen source for operation of the plurality of instances of the metal-air battery 200. For example, the air outlet 1179 may be fluidly connected to GDE air systems as described above. For example, the carbon dioxide removal system 1165 may be disposed in the auxiliary areas 608 and/or 703 shown in FIGS. 7A-C and fluidly connected to the air electrodes of multiple electrochemical cells via an air manifold/distribution system.

In some instances in which the carbon dioxide removal system 1165 includes an air blower 1173 in fluid communication with the column vessel 1167, the carbon dioxide removal system 1165 may further include an air manifold 1174 disposed in the bottom portion of the column vessel 1167. In such instances, the air blower 1173 may be actuatable to direct ambient air into the column vessel 1167 via the air manifold 1174. That is, the air manifold 1174 may be arranged in the bottom portion of the 1172 of the column vessel 1167 such that air moving through the air manifold 1174 (under pressure generated by the air blower 1173) moves in a direction from the bottom portion 1172 of the column vessel 1167 to the top portion 1171 of the column vessel 1167. For example, the air manifold 1174 may define a plurality of first apertures 1175 spaced relative to one another such that ambient air moving through the plurality of first apertures 1175 is distributed across a first face 1176 of the packing material 1168 disposed toward the bottom portion 1172 of the column vessel 1167. That is, the plurality of first apertures 1175 may be spaced relative to one another along the air manifold 1174 to facilitate distribution of the ambient air along at least one dimension of the first face 1176 of the packing material 1168 such that the ambient air may be dispersed (e.g., uniformly) throughout the porous structure of the packing material 1168. Further, or instead, the solution manifold 1169 may define a plurality of second apertures 1177 spaced relative to one another such that the scrubbing solution 1166 moving through the plurality of second apertures 1177 is distributed across a second face 1178 of the packing material 1168 disposed toward the top portion 1171 of the column vessel 1167. The spacing of the plurality of second apertures 1177 relative to one another along the solution manifold 1169 may facilitate dispersion (e.g., uniform dispersion) of the scrubbing solution 1166 throughout the porous structure of the packing material 1168. Thus, in combination, the plurality of first apertures 1175 defined by the air manifold 1174 and the plurality of second apertures 1177 defined by the solution manifold 1169 may facilitate efficient sequestration of carbon dioxide from the ambient air in the scrubbing solution 1166 moving through the packing material 1168. Such efficiency may facilitate forming the column vessel 1167 with a more compact form factor, as compared to other types of relative flow between ambient air and a scrubbing solution.

In some implementations, the carbon dioxide removal system 1165 may further include a porous support 1199 disposed in the column vessel 1167, and the porous support 1199 may support the packing material 1168 away from the air manifold 1174 and/or away from the scrubbing solution 1166 in the column vessel 1167 to facilitate distribution of ambient air along the packing material 1168. The porous support 314 may be a mesh or screen through which fluids may pass, while preventing the packing material 342 from entering the scrubbing solution bottom of the vessel 302.

While the air blower 1173 may push ambient air through the air manifold 1174 and, thus through the packing material 1168 and out of the air outlet 1179 in some instances, it shall be appreciated that other arrangements of the air blower 1173 are additionally or alternatively possible for moving ambient air through the packing material 1168 in the column vessel 1167. For example, as depicted by dashed lines, the air blower 1173 may alternatively be fluidly connected to the air outlet 1179 and actuatable to draw the ambient air through the ambient air through the packing material 1168 in a direction from the bottom portion 1172 of the column vessel 1167 toward the top portion 1171 of the column vessel 1167 and draw the purified air out of the column vessel 1167 via the air outlet 1179. For example, in such instances, the air blower 1173 may be disposed in the air outlet 1179 such that actuation of the air blower 1173 generates a pressure differential across the air outlet 1179 to draw the purified air from the top portion 1171 of the column vessel 1167 through the air outlet 1179.

In some implementations, the carbon dioxide removal system 1165 may additionally, or alternatively, include a controller 1180 having a processing unit 1181 and non-transitory computer-readable storage media 1182 communicatively coupled with one another (e.g., via wired and/or wireless communication). As described in greater detail below, the processing unit 1181 may be in wired and/or wireless communication with one or more sensors and one or more adjustable hardware components of the carbon dioxide removal system 1165, and the non-transitory computer-readable storage media 1182 may have stored thereon computer executable instructions for causing the processing unit 1181 to carry out any one or more of the various different control techniques described herein.

In certain implementations, the carbon dioxide removal system 1165 may further include a liquid flow rate sensor 1183 arranged to detect a flow rate of the scrubbing solution 1166 moving from the pump 1170 to the solution manifold 1169. For example, the controller 1180 (e.g., the processing unit 1181 of the controller 1180) may be communicatively coupled to the liquid flow rate sensor 1183 and to the pump 1170. Continuing with this example, the non-transitory computer readable storage of the 1182 of the controller 1180 may have stored thereon computer readable instructions for causing the processing unit 1181 to receive, from the liquid flow rate sensor 1183, a signal indicative of the flow rate of the scrubbing solution 1166 moving from the pump 1170 to the solution manifold 1169 and, based on the signal from the liquid flow rate sensor 1183, to control the pump 1170 (e.g., the speed of the pump) such that the flow rate of the scrubbing solution 1166 is maintained within a predetermined range of liquid flow rates (e.g., a predetermined range of liquid flow rates that facilitate reaction of the scrubbing solution 1166 with the ambient air in the porous structure of the packing material 1168).

Additionally, or alternatively, the carbon dioxide removal system 1165 may further include a water inlet valve 1184 (e.g., a solenoid valve) selectively actuatable (e.g., via an electromagnetic signal, a hydraulic signal, a mechanical signal, or any combination thereof) to allow water into the scrubbing solution 1166 disposed in the bottom portion 1172 of the column vessel 1167. In certain implementations, the water inlet valve 1184 may be selectively actuated to control operation of the carbon dioxide removal system 1165 according to certain techniques. The water inlet valve 1184 may be fluidly connected to a water source 1189, such as a source of demineralized and/or deionized water, by a water conduit 1190.

In in instances in which the carbon dioxide removal system 1165 includes the water inlet valve 1184, the carbon dioxide removal system 1165 may further include a level sensor 1185 arranged to detect a filling level of the scrubbing solution 1166 in the bottom portion 1172 of the column vessel 1167. Continuing with this example, the controller 1180 (e.g., the processing unit 1181 of the controller 1180) may be communicatively coupled to the level sensor 1185 and to the water inlet valve 1184. The non-transitory computer readable storage of the 1182 of the controller 1180 may have stored thereon computer readable instructions for causing the processing unit 1181 to receive, from the level sensor 1185, a signal indicative of the filling level of the scrubbing solution 1166 in the bottom portion 1172 of the column vessel 1167 and, based on the signal from the level sensor 1185, to control the water inlet valve 1184 such that the filling level of the scrubbing solution 1166 in the bottom portion 1172 of the column vessel 1167 is maintained between a predetermined maximum level and a predetermined minimum level. Stated differently, the processing unit 1181 may open the water inlet valve 1184 to add water to the scrubbing solution 1166 in the bottom portion 1172 of the column vessel 1167, if the level sensor 1185 indicates that the level of the scrubbing solution 1166 is lower than a predetermined minimum level, and the processing unit 1181 may close the water inlet valve 1184, if the level sensor 1185 detects that the level of the scrubbing solution 1166 is equal to or greater than a predetermined maximum level.

Further, or instead, the carbon dioxide removal system 1165 may further include an air pressure sensor 1186 arranged to detect a signal indicative of air pressure within the column vessel 1167. For example, the controller 1180 (e.g., the processing unit 1181 of the controller 1180) may be communicatively coupled to the air pressure sensor 1186 and to the air blower 1173. Continuing with this example, the non-transitory computer readable storage of the 1182 of the controller 1180 may have stored thereon computer readable instructions for causing the processing unit 1181 to receive, from the air pressure sensor 1186, the signal indicative of the air pressure within the column vessel 1167 and, based on the signal from the air pressure sensor 1186, to control the air blower 1173 (e.g., the speed of the air blower 1173) such that the air pressure differential within the column vessel 1167 is maintained within a predetermined range of pressures.

Additionally, or alternatively, the carbon dioxide removal system 1165 may further include a gas flow rate sensor 1187 arranged to measure a gas flow rate of the ambient air through the air blower 1173. For example, the controller 1180 (e.g., the processing unit 1181 of the controller 1180) may be communicatively coupled to the gas flow rate sensor 1187 and to the air blower 1173. Continuing with this example, the non-transitory computer readable storage of the 1182 of the controller 1180 may have stored thereon computer readable instructions for causing the processing unit 1181 to receive, from the gas flow rate sensor 1187, a signal indicative of the gas flow rate of the ambient air through the air blower 1173 and, based on the signal from the gas flow rate sensor 1187, to control the air blower 1173 (e.g., the speed of the air blower 1173) such that the gas flow rate of the ambient air through the air blower 1173 is maintained within a predetermined range of gas flow rates.

In some implementations, the carbon dioxide removal system 1165 may include additional sensors, such as current draw sensors and/or tachometer feedback sensors, to detect a current draw and/or speed of the air blower 1173 and/or of the pump 1170.

In some embodiments, the carbon dioxide removal system 1165 may additionally, or alternatively include a CO₂ sensor 1188 arranged to measure concentration of CO₂ in the purified air. For example, the CO₂ sensor 1188 may be disposed in the air outlet 1179 to measure concentration of CO₂ in the purified air moving through the air outlet 1179. Further, or instead, the CO₂ sensor 1188 may be arranged to measure concentration of CO₂ in the purified air in the top portion 1171 of the column vessel 1167. The CO₂ sensor 1188 may be in communication with the controller 1180, and the controller 1180 may control various operations of the carbon dioxide removal system 1165 based on the measured CO₂ concentration in the purified air, such as adjusting the speed of the air blower 1173, opening or closing the water inlet valve 1184, and/or adjusting the speed of the pump 1170.

During operation, ambient air may be provided to the air manifold 1174 by the air blower 1173. The air manifold 1174 may direct ambient air into the packing material 1168 in a direction from the bottom portion 1172 of the column vessel 1167 toward the top portion 1171 of the column vessel 1167. As compared to directing air without the use of the air manifold 1174, the air manifold 1174 may increase the uniformity of air flow into and/or through the packing material 1168. The air may flow upwards through the packing material 1168 and into an open space at the top portion 1171 of the column vessel 1167, due to a pressure differential between the bottom portion 1172 of the column vessel 1167 and the top portion 1171 of the column vessel 1167. The air purified air may exit the top portion 1171 of the column vessel 1167 through the air outlet 1179 and flow for distribution to the plurality of instances of the metal-air battery 200.

The scrubbing solution 1166 may be collected in the bottom portion 1172 of the column vessel 1167. The scrubbing solution 340 may be output from the column vessel 1167 via a solution outlet 1191. The pump 1170 may pump the scrubbing solution 1166 through the solution outlet 1191 to the solution manifold 1169. The scrubbing solution 1166 may flow downward through the packing material 1168 due to the force of gravity.

As ambient air and the scrubbing solution 1166 flow in opposite directions through the packing material 1168, and the packing material 1168 increases the contact between the ambient air and the scrubbing solution 1166. As such, the packing material 1168 increases the reaction between the carbon dioxide sequestering material in the scrubbing solution 1166 and the carbon dioxide in the air, thus increasing the amount of carbon dioxide removed from the air and sequestered as a carbonate. As such, purified air having a low carbon dioxide content may be collected at the top portion 1171 of the column vessel 1167.

While carbon dioxide removal systems have been described as including a packing material, it shall be appreciated that other techniques for exposing ambient air to a scrubbing solution are additionally or alternatively possible. For example, referring now to FIGS. 1-10 and FIG. 12, a carbon dioxide removal system 1265 may include a column vessel 1267, a scrubbing solution 1266, an air sparger 1292, an air blower 1273, a demister 1293, and an air outlet 1279. The column vessel 1267 may have a top portion 1271 and a bottom portion 1272 opposite one another. The scrubbing solution 1266 may be disposed in the bottom portion 1272 of the column vessel 1267. The air sparger 1292 may be immersed in the scrubbing solution 1266 in the column vessel 1267. The air sparger 1292 may include openings that generate fine air bubbles as actuation of the air blower 1273 moves ambient air into the scrubbing solution 1266 via the air sparger 1292. The air bubbles may rise through the scrubbing solution 1266 and carbon dioxide in the ambient air may react with the scrubbing solution 1266 to form carbonate, resulting in purified air. The purified air may emerge from the surface of the scrubbing solution 1266 and enter the top portion 1271 of the column vessel 1267. The purified air may exit the column vessel 1267 through the air outlet 1279 and may move for distribution to air electrodes of electrochemical cells.

The air blower 1273 may be actuatable to generate air bubbles in the scrubbing solution 1266 via the air sparger 1292 immersed in the scrubbing solution. The demister 1293 may be disposed in the top portion 1271 of the column vessel 1267 such that vapor from the scrubbing solution 1266 in the bottom portion 1272 of the column vessel 1267 is condensable in the demister 1293. The air outlet 1279 may be in fluid communication with the top portion of the column vessel 1267 such that the purified air from the scrubbing solution 1266 is movable out of the column vessel 1267 via the air outlet 1279.

The demister 1293 may be disposed along the top portion 1271 of the column vessel 1267 (e.g., adjacent to the surface of the scrubbing solution 1266). The demister 1293 collect and condense vapor formed above the scrubbing solution 1266 due to air bubbles rising out of the scrubbing solution 1266. The demister 1293 may return the condensate to the scrubbing solution 1266 disposed in the bottom portion 1272 of the column vessel 1267.

Having described carbon dioxide removal systems as include scrubbing solutions, it shall be appreciated that other types of material may be additionally or alternatively used to remove carbon dioxide from ambient air. For example, referring now to FIGS. 1-10 and FIG. 13, a carbon dioxide removal system 1365 may include a column vessel 1267, a scrubbing material 1394, an air manifold 1374, an air blower 1373, and an air outlet 1379. The column vessel 1367 may have a top portion 1371 and a bottom portion 1372. The scrubbing material may be disposed in the column vessel 1267 between the top portion 1371 and the bottom portion 1372. The air manifold 1374 may be disposed in the bottom portion 1372 of the column vessel 1267 such that the ambient air may be movable onto a first side 1395 of the scrubbing material 1394. The air blower 1373 may be actuatable to move the ambient air through the air manifold 1374. The air outlet 1379 may be in fluid communication with the top portion 1371 of the column vessel 1367, and the purified air may exiting a second side 1396 (e.g., opposite the first side 1395) of the scrubbing material 1394 may be movable out of the column vessel 1367 via the air outlet 1379. As compared to the use of scrubbing solutions, the use of the scrubbing material 1394 reduces the need for separate handling equipment associated with a scrubbing solution.

The scrubbing material 1394 may be a porous material, such as granulated sodium hydroxide (NaOH), potassium hydroxide (KOH), calcium hydroxide (Ca(OH)2), lithium hydroxide (LiOH), soda lime, lithium peroxide (Li2O2), activated carbon, combinations thereof, or the like. In some embodiments, the carbon dioxide scrubbing material may be a metal-organic framework (MOF) that may sequester carbon dioxide.

In some embodiments, the carbon dioxide removal system 1365 may additionally, or alternatively, include a humidifier 1397 and a humidity sensor 1398. The humidifier 1397 may be connected to a water source 1389 and may humidify air forced into the column vessel 1367 by the air blower 1273, via the air manifold 1374. For example, a controller 1380 may control the operation of the humidifier 1397, based on a humidity detected by the humidity sensor 1398 and a humidity requirement of the scrubbing material 1394.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, unless otherwise specified or made clear from the context, the term “about” may refer to a variation of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims.

What is claimed is:

1. A system for electrochemical power storage, the system comprising:
a plurality of instances of a metal-air battery, each instance of the metal-air battery including
an air electrode,
a metal electrode, and
a liquid electrolyte separating the air electrode from the metal electrode with the air electrode and the metal electrode ionically coupled to one another via the liquid electrolyte; and
a carbon dioxide removal system into which ambient air is directable, carbon dioxide from the ambient air removable in the carbon dioxide removal system to generate purified air, and the carbon dioxide removal system in fluid communication with the plurality of instances of the metal-air batteries such that the purified air is movable from the carbon dioxide removal system to the plurality of instances of the metal-air battery.

2. The system of claim 1, wherein the carbon dioxide removal system includes a scrubbing solution in which carbon dioxide from the ambient air is sequesterable to form purified air.

3. The system of claim 2, wherein the scrubbing solution comprises one or more of the following dissolved in a liquid solvent: sodium hydroxide (NaOH), potassium hydroxide (KOH), calcium hydroxide (Ca(OH)₂), lithium hydroxide (LiOH), or lithium peroxide (Li₂O₂).

4. The system of claim 2, wherein the carbon dioxide removal system includes
a column vessel having a top portion and a bottom portion opposite one another, the scrubbing solution disposed in the bottom portion of the column vessel,
a packing material disposed in the column vessel between the top portion and the bottom portion, the packing material having a porous structure,
a solution manifold disposed in the top portion of the column vessel, the solution manifold arranged to direct the scrubbing solution onto the packing material in a direction from the top portion of the column vessel toward the bottom portion of the column vessel, and
a pump actuatable to move the scrubbing solution from the bottom portion of the column vessel to the solution manifold.

5. The system of claim 4, further comprising
a liquid flow rate sensor configured to detect a flow rate of the scrubbing solution moving from the pump to the solution manifold, and
a controller communicatively coupled to the liquid flow rate sensor and to the pump, the controller configured to receive, from the liquid flow rate sensor, a signal indicative of the flow rate of the scrubbing solution moving from the pump to the solution manifold and, based on the signal from the liquid flow rate sensor, to control the pump such that the flow rate of the scrubbing solution is maintained within a predetermined range of liquid flow rates.

6. The system of claim 4, wherein the carbon dioxide removal system further comprises an air blower in fluid communication with the column vessel, wherein the air blower is actuatable to generate an air pressure differential within the column vessel, and the air pressure differential moves the ambient air through the packing material in a direction from the bottom portion of the column vessel toward the top portion of the column vessel.

7. The system of claim 6, wherein the carbon dioxide removal system further includes
an air manifold disposed in the bottom portion of the column vessel, the air blower in fluid communication with the air manifold, and the air blower is actuatable to direct the ambient air into the column vessel, via the air manifold, and through the packing material in a direction from the bottom portion of the column vessel toward the top portion of the column vessel.

8. The system of claim 7, wherein the carbon dioxide removal system further includes a porous support disposed in the column vessel, and the porous support supports the packing material away the air manifold.

9. The system of claim 7, wherein
the air manifold defines a plurality of first apertures spaced relative to one another such that ambient air moving through the plurality of first apertures is distributed across a first face of the packing material disposed toward the bottom portion of the column vessel, and
the solution manifold defines a plurality of second apertures spaced relative to one another such that the scrubbing solution moving through the plurality of second apertures is distributed across a second face of the packing material disposed toward the top portion of the column vessel.

10. The system of claim 6, wherein the carbon dioxide removal system further includes an air outlet in fluid communication with the top portion of the column vessel, and the purified air from the packing material is movable out of the column vessel via the air outlet.

11. The system of claim 10, wherein the air blower is actuatable to draw the ambient air through the packing material in a direction from the bottom portion of the column vessel toward the top portion of the column vessel and draw the purified air out of the column vessel via the air outlet.

12. The system of claim 6, further comprising
an air pressure sensor arranged to measure a signal indicative of air pressure within the column vessel, and
a controller communicatively coupled to the air blower and to the air pressure sensor, the controller configured to receive, from the air pressure sensor, the signal indicative of the air pressure within the column vessel and, based on the signal from the air pressure sensor, to control the air blower such that the air pressure differential within the column vessel is maintained within a predetermined range of pressures.

13. The system of claim 6, further comprising
a gas flow rate sensor arranged to measure a gas flow rate of the ambient air through the air blower, and
a controller communicatively coupled to the air blower and to the gas flow rate sensor, the controller configured to receive, from the gas flow rate sensor, a signal indicative of the gas flow rate of the ambient air through the air blower and, based on the signal from the gas flow rate sensor, to control the air blower such that the gas flow rate of the ambient air through the air blower is maintained within a predetermined range of gas flow rates.

14. The system of claim 4, wherein the carbon dioxide removal system further includes a water inlet valve selectively actuatable to allow water into the scrubbing solution disposed in the bottom portion of the column vessel.

15. The system of claim 14, wherein the carbon dioxide removal system further includes
a level sensor arranged to detect a filling level of the scrubbing solution in the bottom portion of the column vessel, and
a controller communicatively coupled to the water inlet valve and to the level sensor, the controller configured to receive, from the level sensor, a signal indicative of the filling level of the scrubbing solution in the bottom portion of the column vessel and, based on the signal from the level sensor, to control the water inlet valve such that the filling level of the scrubbing solution in the bottom portion of the column vessel is maintained between a predetermined maximum level and a predetermined minimum level.

16. The system of claim 2, wherein the carbon dioxide removal system includes
a column vessel having a top portion and a bottom portion, the scrubbing solution disposed in the bottom portion of the column vessel,
an air sparger immersed in the scrubbing solution in the column vessel,
an air blower actuatable to generate air bubbles in the scrubbing solution via the air sparger immersed in the scrubbing solution,
a demister disposed in the top portion of the column vessel, vapor from the scrubbing solution in the bottom portion of the column vessel condensable in the demister, and
an air outlet in fluid communication with the top portion of the column vessel, the purified air from the scrubbing solution movable out of the column vessel via the air outlet.

17. The system of claim 1, wherein the carbon dioxide removal system includes
a column vessel having a top portion and a bottom portion,
a scrubbing material having a first side and a second side opposite one another, the scrubbing material having a porous structure from the first side to the second side, carbon dioxide from the ambient air moving through the porous structure sequesterable in the scrubbing material, and the scrubbing material disposed in the column vessel between the top portion and the bottom portion,
an air manifold disposed in the bottom portion of the column vessel, the ambient air movable onto the first side of the scrubbing material via the air manifold;
a blower actuatable to move the ambient air through the air manifold; and
an air outlet in fluid communication with the top portion of the column vessel, the purified air from the second side of the scrubbing material movable out of the column vessel via the air outlet.

18. The system of claim 17, wherein the scrubbing material comprises a metal-organic framework (MOF) in which the carbon dioxide is sequesterable.
